(19) United States
(12) Patent Application Publication
(10) Pub. No.: US 2002/0164069 A1
(43) Pub. Date: Nov. 7, 2002

(54) Optical modeling device and exposure unit

(75) Inventors: Kazuhiko Nagano, Kanagawa (JP); Yoji Okazaki, Kanagawa (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/074,258

(22) Filed: Feb. 14, 2002

(30) Foreign Application Priority Data
Feb. 16, 2001 (JP) 2001-40756
Sep. 10, 2001 (JP) 2001-274360

(51) Int. Cl. G06K 9/00

(52) U.S. Cl. 382/154

(57) ABSTRACT

When a first position of an exposure unit is determined by an XY positioning mechanism, a micromirror of a digital micromirror device is on/off controlled in accordance with image data within a region of a predetermined area including the first position, a light beam emitted from a light source enters the digital micromirror device, through an optical fiber and a homogenizer optical system, and modulated per each data in accordance with image data. A light beam transmitted to a reflective mirror is condensed by a condensing lens, then reflected from the reflected mirror onto a surface of a photo-curable resin, a portion within a region of a predetermined area of the photo-curable resin surface is exposed by the light beam, and the exposed portion is cured. In the same manner, the entire resin surface is exposed by repeating movement and/or exposure of the exposure unit.

### BACKGROUND OF THE INVENTION

1. Field of the Invention

The present invention relates to an optical modeling device and an exposure unit. More particularly, the present invention relates to an optical modeling device for forming a three-dimensional model by exposing a photo-curable resin with a light beam and an exposure unit that can suitably be used for the optical modeling device.

2. Description of the Related Art

Lately, with the spread of a three-dimensional CAD (Computer Aided Design) system, an optical modeling system has come into general use in which a photo-curable resin is exposed with a light beam on the basis of CAD data, a three-dimensional object produced in a virtual space on the computer is modeled to an actual three-dimensional model by using the three-dimensional CAD system. The optical modeling system comprises the steps of creating a plurality of cross sectional data by slicing CAD data at regular intervals; hardening the photo-curable resin into layers by scanning the surface of a liquid type photo-curable resin with the irradiation of laser light on the basis of each cross sectional data; and modeling a three-dimensional model by layering a photo-curable resin layer sequentially. As an optical modeling method, a free liquid surfacing method is widely known in which a liquid type photo-curable resin is reserved in an open top reservoir beforehand, and a photo-curable resin layer is layered while gradually sinking a modeling table disposed near the liquid surface of the photo-curable resin from a free liquid surface of the photo-curable resin.

A conventional optical modeling device used for such an optical modeling system is divided into a laser plotter type optical modeling device using a laser plotter for scanning and a movable mirror type modeling device using a movable mirror for scanning. Both types of the optical modeling devices can be referred to an issue titled, “foundation, status quo, issues, and molding technology of an optical modeling system” (published by Yoji Maruya: volume 7, No. 10, pp 18 to 23, 1992).

The laser plotter type optical modeling device is shown in FIG. 32. In this device, laser light oscillated from a laser light source 250 is transmitted to an XY plotter 256 through an optical fiber 254 having a shutter 252, and irradiated from the XY plotter 256 onto a liquid surface 266 of a photo-curable resin 262 in a container 260. Further, positions of the XY plotter 256 in X and Y directions are controlled by an XY positioning mechanism 258 comprising an X positioning mechanism 258a and a Y positioning mechanism 258b. Therefore, the laser light irradiated from the XY plotter 256 is on/off controlled by using the shutter 252 in accordance with cross sectional data, while shifting the XY plotter 256 in X and Y directions, whereby a predetermined portion of the photo-curable resin 262 on the liquid surface 266 can be cured.

However, in the laser plotter type optical modeling device, a problem is caused that a shutter speed or a moving speed of the plotter is limited thus requiring much time for modeling.

A movable mirror type optical modeling device using a conventional galvanometer mirror is shown in FIG. 33. In this device, laser light 270 is reflected from an X axis rotation mirror 272 and a Y axis rotation mirror 274 and is then irradiated onto the photo-curable resin 262. The X axis rotation mirror 272 controls a position at which the laser light is irradiated in X direction while rotating around a Z axis as a rotation axis. The Y axis rotation mirror 274 controls a position at which the laser light is irradiated in Y direction while rotating around an X axis as a rotation axis. The scanning speed with this movable mirror type optical modeling device is higher than the laser plotter type one.

The movable mirror type optical modeling device scans image data by fine spot scanning. Therefore, when image data is scanned at high speed of 2 to 12 m/s, for example, it takes 8 to 24 hours to model only a 10 cm³ of three-dimensional model thus requiring much time for modeling. Further, when the laser light 270 is reflected from the Y axis rotation mirror 274, the angle at which the laser light 270 enters the Y axis rotation mirror 274 must be within a predetermined range thus limiting a region within which the laser light 270 is irradiated (laser light irradiating region). Therefore, in order to widen the laser light irradiating region, when the Y axis rotation mirror 274 is positioned higher than the photo-curable resin 262 and separated therefrom, a problem is caused that a laser spot diameter increases, positioning accuracy deteriorates, and modeling accuracy thereby deteriorates. Moreover, when a rotation angle of the Y axis rotation mirror 274 is widened, the laser light irradiating region is enlarged. However, in a similar way as described above, positioning accuracy deteriorates, and the number of pincushion errors increases. In addition, the optical modeling device using the galvanometer mirror may cause a problem in that an optical system adjustment such as distortion correction or optical axis adjustment becomes complicated, whereby the optical system becomes complicated thus making the entire device larger.

In both of the optical modeling devices described above, an UV laser light source capable of outputting high power is used as a light source. Conventionally, gas laser such as argon laser or solid laser using THG (third harmonics) has been generally used as the light source. However, regarding gas laser, maintenance such as gas filling takes a lot of time and labors. Besides, in the optical modeling device using gas laser as a light source, problems have been caused in that the gas laser is expensive, an optical modeling device using gas laser requires higher manufacturing cost and another equipment such as a cooling chiller, whereby the entire optical modeling device is made larger. On the other hand, in the optical modeling device using THG solid laser as a light source, problems have been caused in that, since the THG solid laser is pulse-operated by Q switching, pulse is operated at a low repetitive rate. Accordingly, the THG solid laser was unsuitable for a high speed exposure. Further, when the THG solid laser is used as a light source, the wavelength-converting efficiency deteriorates thus making a laser light source impossible to output high power. Therefore, a problem has been caused in that use of high power excitation semiconductor lasers is needed so that the optical modeling device must be manufactured at more expense.

In view of the aforementioned facts, Japanese Patent Application Laid-Open (JP-A) No. 11-138645 proposes an optical modeling device comprising multiple light sources capable of irradiating regions to be exposed with a spot which is larger than one single pixel, the optical modeling device multi-exposing pixels with the multiple light sources. In the device, since pixels are multi-exposed with the multiple light sources, each of the light sources need not output high power, inexpensive light emitting diodes (LEDs) can be used as the light sources.

However, the optical modeling device disclosed in the JP-A No. 11-138645 causes such problems that, since each light source has a spot size which is larger than one single pixel, such a light source cannot be used for modeling with high accuracy, and since pixels are multi-exposed by using multiple light sources, more useless operations are needed so that a lot of time is required for modeling. Further, this disclosure causes a problem in that the more the number of light sources, the larger the exposing portion of the device. Moreover, there is a possibility that multi-exposure in a light amount of LEDs does not necessarily result in a sufficient image resolution.

### SUMMARY OF THE INVENTION

In view of the aforementioned facts, an object of the present invention is to provide an optical modeling device capable of modeling at high speed and with high accuracy. Another object of the present invention is to provide an exposure unit which is made more compact than a conventional one and which can be arranged in multiple rows at an exposure portion. Yet another object of the present invention is to provide an optical modeling device and an exposure unit that can be manufactured inexpensively.

A first aspect of the present invention is an optical modeling device in which a light beam is exposed onto a photo-curable resin to form a three-dimensional model, the device comprising: an exposure portion for exposing a plurality of pixels within a predetermined region of a surface of the photo-curable resin by using the light beam emitted from a light source and modulated for each pixel in accordance with image data; and a moving portion connected to the exposure portion for moving the exposure portion relative to the surface of the photo-curable resin.

In accordance with the optical modeling device according to the first aspect of the present invention, since a plurality of pixels within a predetermined region of a surface of the photo-curable resin is exposed by the light beam emitted from a light source and modulated for each pixel in accordance with image data, the pixels within the predetermined region of the surface of the photo-curable resin can be cured at one time, whereby high speed modeling is made possible. Then, since the moving portion moves the exposure portion relative to the surface of the photo-curable resin, an area of the predetermined region which is to be exposed at one time by the exposure portion is limited, whereby spatial resolution can be improved, and modeling with high accuracy is made possible.

In this case, the exposure portion is able to comprise the light source, and a spatial light modulator for modulating the light beam emitted from the light source for each pixel in accordance with image data. It is preferable that the spatial light modulator comprises a digital micromirror device.

A second aspect of the present invention is an optical modeling device in which a light beam is exposed onto a photo-curable resin to form a three-dimensional model, the device comprising: an exposure portion for exposing a plurality of pixels within a predetermined region of a surface of the photo-curable resin by using the light beam emitted from a light source, modulated for each pixel in accordance with image data, and pulse-driven in picosecond pulses; and a moving portion connected to the exposure portion for moving the exposure portion relative to the surface of the photo-curable resin.

In accordance with the optical modeling device according to the second aspect of the present invention, since a plurality of pixels within a predetermined region of a surface of the photo-curable resin is exposed by the light beam emitted from a light source and modulated for each pixel in accordance with image data, the pixels within the predetermined region of the surface of the photo-curable resin can be cured at one time, whereby high speed modeling is made possible. Then, since the exposure portion is able to scan the photo-curable resin surface, and the moving portion moves the exposure portion relative to the surface of the photo-curable resin, an area of the predetermined region which is to be exposed at one time by the exposure portion is limited, whereby spatial resolution can be improved, and modeling with high accuracy is made possible.

In this case, the exposure portion comprises the light source, and a spatial light modulator array in which spatial light modulators, for modulating the light beam emitted from the light source for each pixel in accordance with image data, are arranged in a first scanning direction (e.g. main-scanning direction). By the spatial light modulators, the photo-curable resin surface is scanned and exposed in the first scanning direction. The spatial light modulator comprises one of a digital micromirror device and a grating light valve (GLV). A more detailed description of the grating light valve is given in U.S. Pat. No. 5,311,360.

The exposure portion is able to comprise the light source, a spatial light modulator array in which spatial light modulators for modulating the light beam emitted from the light source for each pixel in accordance with image data are arranged in a first scanning direction, and a scanning mirror for scanning in a second scanning direction intersecting the first scanning direction. The photo-curable resin surface is scanned and exposed by the scanning mirror (movable mirror or scanner mirror) in the second scanning direction. The moving portion moves the exposure portion in the first scanning direction and the second scanning direction intersecting the first scanning direction.

Any of the optical modeling devices has at least one exposure portions, and each of the exposure portions is independently movable relative to the surface of the photo-curable resin, whereby modeling at higher speed is made possible.

A third aspect of the present invention is an optical modeling device in which a light beam is exposed onto a photo-curable resin to form a three-dimensional model, the device comprising an exposure portion which includes a plurality of exposure units arranged in an array, each exposure unit scanning and exposing a plurality of pixels within a predetermined region of a surface of the photo-curable resin by using a light beam emitted from a light source and modulated for each pixel in accordance with image data.

In accordance with the optical modeling device according to the third aspect of the present invention, since each of the exposure units arranged in an array at the exposure portion scans and exposes the pixels within the predetermined region of the surface of the photo-curable resin by the light beam emitted from a light source and modulated for each pixel in accordance with image data, whereby modeling at high speed and with high accuracy is made possible.

In the optical modeling device, the exposure unit can comprise the light source, a condensing optical system for condensing the light beam emitted from the light source, and a deflecting element for modulating the light beam condensed by the condensing optical system for each pixel in accordance with image data. Since the exposure unit uses the deflecting element for modulating the light beam for each pixel in accordance with image data, the exposure unit is made compact as compared to a case in which a conventional set of two movable mirrors is used. Therefore, multiple exposure units can be arranged at the exposure portion. Further, modeling at high speed and with high accuracy is enabled. The exposure region to be exposed by one exposure unit is reduced so that pincushion errors can be minimized. Moreover, this exposure unit can be formed such that the light source, the condensing optical system, and the deflecting element are enclosed in a package. As the deflecting element, a two-dimensional microscanner can be used.

In the optical device of the present invention, preferably, the light source is able to comprise one of: a gallium nitride semiconductor laser; a semiconductor laser excitation solid laser in which a laser beam caused by excitation of a solid laser crystal by a gallium nitride semiconductor laser is wavelength-converted by an optical wavelength-converting element, and emitted, a fiber laser or fiber amplifier in which a laser beam caused by excitation of a fiber by an infrared light-emitting semiconductor laser is wavelength-converted by an optical wavelength-converting element, and emitted, and a fiber laser in which a laser beam caused by excitation of a fiber by a gallium nitride semiconductor laser is wavelength-converted by an optical wavelength-converting element, and emitted.

In the optical modeling device of the present invention, the light source may comprise one of a first laser light source in which a gallium nitride semiconductor laser is coupled to a fiber, a second laser light source in which a plurality of gallium nitride semiconductor lasers is coupled to a fiber through a multiplexing optical system, a linear laser light source in which a plurality of fibers of at least one of the first laser light source and the second laser light source is arranged in an array so as to emit a linear laser luminous flux, and an area laser light source in which a plurality of fibers of at least one of the first laser light source and the second laser light source is arranged in a bundle so as to emit a spot laser luminous flux.

These are laser light sources capable of outputting high power of several 10 watts by being continuously driven or pulse-driven and emitting a laser light within a predetermined wavelength region including UV region (e.g. 350 nm to 420 nm, preferably, 405 nm), which was impossible with conventional laser light sources. Use of these laser light sources makes it unnecessary to use expensive gas laser or THG solid laser, whereby the laser light sources can output extremely high power, which was impossible with the conventional laser light sources. Accordingly, an optical modeling device and an exposure unit can model at higher speed and with higher accuracy and can be manufactured inexpensively 10 times or more than in conventional optical modeling device and exposure unit.

In the above-described optical modeling device, the surface of the photo-curable resin is exposed by the light beam which is emitted from the light source and pulse-driven, whereby thermal diffusion due to the irradiation of the light is prevented and exposure at high speed and with high accuracy is made possible. Therefore, the shorter the pulse width of the laser light which has been pulse-driven the more acceptable, namely, a suitable pulse width is preferably 1psec to 100 nsec, and more preferably 1 psec to 300 psec. Besides the laser light sources described above can output high power which was impossible with the conventional light sources, the laser light sources can oscillate in a short pulse picosecond order and can expose at high speed and with high accuracy. A predetermined wavelength region including UV region is preferably 350 to 420 nm, and more preferably 405 nm at which outputting of a maximum power can be expected by using an inexpensive gallium nitride semiconductor laser.

Specific examples of laser light sources are described below:

(1) A gallium nitride semiconductor laser.

For example, a gallium nitride semiconductor laser having a broad area light emitting region, a 10 mm long-bar type semiconductor laser, and a semiconductor laser comprising a gallium nitride semiconductor laser chip having a plurality of light emitting points can be used. Further, when an array type semiconductor laser disclosed in Japanese Patent Application Laid-Open (JP-A) No. 2001-273849, higher output can be expected;

(2) A semiconductor laser excitation solid laser in which a laser beam obtained by excitation of a solid laser crystal by the gallium nitride semiconductor laser is wavelength-converted by an optical wavelength-converting element, and emitted, and examples thereof include: a solid laser crystal to which at least Pr³⁺ is added as a rare-earth ion, a gallium nitride semiconductor laser for emitting a laser beam which excites the solid laser crystal, and a semiconductor laser excitation solid laser comprising an optical wavelength-converting element by which a wavelength of the laser beam obtained by excitation of the solid laser crystal is converted to UV light.

The solid laser crystal to which Pr³⁺ has been added is excited by a GaN semiconductor laser, and oscillates effectively at a wavelength within a range of 700 to 800 nm. Namely, due to a transition of ³P₀→³F₄, an infrared solid laser beam of a wavelength 720 nm which is an oscillating line of Pr³⁺ is oscillated efficiently. Therefore, if the solid laser beam is wavelength-converted to an SHG (second harmonics) by the optical wavelength-converting element, high intensity UV light of a wavelength 360 nm can be obtained. Further, as compared to a case of generating a THG (third harmonics), the structure is not complicated in generating the SHG, whereby a semiconductor laser excitation solid laser is implemented at less expense. Moreover, a continuous operation facilitates wavelength- converting with high efficiency, whereby high outputting characteristics can be obtained.

(3) A fiber laser in which a laser beam obtained by excitation of a fiber by the gallium nitride semiconductor laser is wavelength-converted by an optical wavelength-converting element, and emitted, and examples thereof include: a fiber which has a core in which at least one of Er³⁺, Ho³⁺, Dy³⁺, Eu³⁺, Sn³⁺, Sm³⁺, and Nd³⁺, and Pr³⁺ are doped; a gallium nitride semiconductor laser for emitting a laser beam that excites the fiber; and a fiber laser comprising an optical wavelength-converting element by which a laser beam obtained by excitation of the fiber is wavelength-converted to UV light;

Each of Er³⁺, Ho³⁺, Dy³⁺, Eu³⁺, Sn³⁺, Sm³⁺, and Nd³⁺ has an absorption band in wavelengths of 380 to 430 nm, and can be excited by the GaN semiconductor laser. Excited electrons are energy-shifted to an excited level of Pr³⁺ and then transited to a lower level, and the fiber laser is enabled to oscillate in cyan, green, and magenta regions as oscillating lines of Pr³⁺. The wavelengths of 380 to 430 nm are a wavelength region in which the GaN semiconductor laser is comparatively apt to oscillate. Since wavelengths of 400 to 410 nm are especially a wavelength region in which a maximum output of the GaN semiconductor laser is obtained, if Er³⁺, Ho³⁺, Dy³⁺, Eu³⁺, Sn³⁺, Sm³⁺, and Nd³⁺ are excited by the GaN semiconductor laser, the amount in which the excited light is absorbed becomes larger, high efficiency and high outputting can be accomplished. Further, the number of optical components are reduced, the structure of the device is simplified, and loss due to excitation is minimized, whereby temperature stable region can be increased.

As a GaN semiconductor laser which is an excitation light source, besides a single row or column mode type of the GaN semiconductor can be used, one or more of other types such as broad area type, multi-array type, phased-array type, MOPA type GaN semiconductor lasers, and a high power outputting fiber type GaN semiconductor laser in which the GaN semiconductor laser is multiplexed and coupled to a fiber can be used. A fiber laser can be used as the excitation light source. In this way, obtaining of higher power of W (watt) class is made possible by using such high outputting type GaN semiconductor lasers. When a laser is used in which Pr³⁺ having a broad emitting spectrum is used and which has been described in the (2) and (3), psec pulse driving is facilitated by a mode lock, and operation at high repetitive rate is made possible. Further, due to psec operation, wavelength-converting with high efficiency is enabled.

(4) A fiber laser or fiber amplifier in which a laser beam obtained by excitation of a fiber by an infrared light-emitting semiconductor laser is wavelength-converted by an optical wavelength-converting element, and emitted, and examples thereof include: a fiber laser whose core is Nd³⁺ doped, Yb³⁺ doped, or Er³⁺ and Yb³⁺ doped; and a fiber laser or fiber amplifier having an optical wavelength-converting element by which a laser beam obtained by excitation of the fiber is wavelength-converted to UV light. As the optical wavelength-converting element, a THG (third harmonics) element and an FHG (fourth harmonics) can be used.

Use of such fiber lasers can improve a mode matching between the excited light and the oscillated beam as compared to a conventional solid laser, whereby modeling with higher efficiency is enabled. Further, in the case of the fiber laser system, the mode lock mechanism can be structured more stably and at less expense than in the conventional solid laser, whereby short pulse driving (psec) and operation at high repetitive rate are enabled by using a rare-earth element that provides a broad oscillating spectrum in the aforementioned fiber laser. Consequently, THG light and FHG light can be obtained by a wavelength-converting at high efficiency.

Also in the fiber amplifier, by using LD light in which a species light source can be operated at high repetitive rate and pulse-driven in short pulses, higher power can be outputted by the fiber amplifier, and the THG light and the FHG light can be obtained by wavelength-converting at high efficiency. Thus, laser light outputting higher power and operating at higher repetitive rate than the conventional solid laser can be obtained. Consequently, a light source suitable for an exposure at high speed can be manufactured inexpensively.

(5) A laser comprising a gallium nitride semiconductor laser which is multiplexed to a fiber.

For example, as disclosed in JP-A Nos. 2001-273870 and 2001-2738718, a plurality of the gallium nitride semiconductor lasers is multiplexed by an optical multiplexer so that high power can be outputted from the fiber. A fiber in which a semiconductor laser comprising a semiconductor laser chip for emitting a plurality of light beams is multiplexed by a condensing optical system can be used. Further, gallium nitride semiconductor beams having a broad area light-emitting region can be multiplexed to a fiber. Arranging these fibers in an array forms a linear light source or arranging these fibers in a bundle forms an area light source, whereby higher power can be outputted.

(6) The light source may comprise multiple laser light sources and the multiplexing optical system for multiplexing the laser beams emitted from the multiple laser light sources. A laser light source can use one of the above-described (1) to (5) laser light sources. Multiplexing the laser beams emitted from the multiple laser light sources by using the multiplexing optical system enables light sources to output higher power.

The gallium nitride semiconductor laser, which is a semiconductor laser, can be manufactured inexpensively. Further, the gallium nitride semiconductor laser whose transition mobility is very low and whose heat conductivity coefficients are very high has an extremely high COD (Catastrophic Optical Damage) value. Further, the gallium nitride semiconductor laser, which is a semiconductor laser, can be pulse-driven and operated at high repetitive rate in short cycles of pulses having high peak power, whereby exposure at high speed and with high accuracy is made possible. Accordingly, use of the gallium nitride semiconductor laser as a light source enables an exposure unit to expose at less expense, at high speed, and with high accuracy.

### BRIEF DESCRIPTION OF THE DRAWINGS

FIG. 1 is a perspective view of a schematic structure of an optical modeling device according to a first embodiment of the present invention;

FIG. 2 is a partial enlargement view of a structure of an exposure unit of the optical modeling device according to the first embodiment of the present invention;

FIG. 3A is a plan view of a structure of ultraviolet light source of a layering modeling device according to the first embodiment of the present invention;

FIG. 3B is a plan view of end surfaces of fibers arranged in a bundle in the first embodiment of the present invention;

FIG. 4 is a graph illustrating transmitting characteristics of a narrow band filter of the light source shown in FIGS. 3A and 3B.

FIG. 5A is a partial enlargement view of a structure of a DMD;

FIG. 5B is a partial enlargement view of the structure of the DMD;

FIG. 5C is a partial enlargement view of the structure of the DMD;

FIG. 6A is an explanatory view for explaining an operation of the DMD;

FIG. 6B is an explanatory view for explaining an operation of the DMD;

FIG. 7 is a schematic cross-sectional view of an example of a layered structure of a GaN semiconductor laser having a broad area light-emitting region as a light source used for the optical modeling device according to the first embodiment of the present invention;

FIG. 8 is a schematic cross-sectional view of an example of a structure of a semiconductor laser excitation solid laser as a light source used for the optical modeling device according to the first embodiment of the present invention;

FIG. 9 is a schematic cross-sectional view of an SHG (second harmonics generating) fiber laser as a light source used for the optical modeling device according to the first embodiment of the present invention;

FIG. 10 is a schematic cross-sectional view of an FHG (fourth harmonics generating) fiber laser as a light source used for the optical modeling device according to the first embodiment of the present invention;

FIG. 11 is a perspective view of a schematic structure of an optical modeling device according to a second embodiment of the present invention;

FIG. 12 is a perspective view of a schematic structure of an optical modeling device according to a third embodiment of the present invention;

FIG. 13A is a plan view of a structure of an exposure unit of the optical modeling device according to the third embodiment of the present invention;

FIG. 13B is a cross-sectional view taken along an optical axis of FIG. 13A;

FIG. 14A is a plan view of a variant example of an exposure unit of the optical modeling device according to the third embodiment of the present invention;

FIG. 14B is a cross-sectional view taken along an optical axis of FIG. 14A;

FIG. 15A is a plan view of a variant example of the exposure unit of the optical modeling device according to the third embodiment of the present invention;

FIG. 15B is a cross-sectional view taken along an optical axis of FIG. 15A;

FIG. 16A is a plan view of a variant example of the exposure unit of the optical modeling device according to the third embodiment of the present invention;

FIG. 16B is a cross-sectional view taken along an optical axis of FIG. 16A;

FIG. 17 is a perspective view of an optical modeling device according to a fourth embodiment of the present invention;

FIG. 18 is a perspective view of light sources used in the fourth embodiment of the present invention;

FIG. 19 is a perspective view of semiconductor laser chips at a light source;

FIG. 20A is a plan view of semiconductor laser chips at a light source;

FIG. 20B is a cross-sectional view taken along an optical axis of FIG. 20A;

FIG. 21A is a perspective view of a variant example of the optical; modeling device according to the fourth embodiment of the present invention;

FIG. 21B is a perspective view of a variant example of the optical; modeling device according to the fourth embodiment of the present invention;

FIG. 22 is a perspective view of a schematic structure of a grating light valve (GLV) element used as a light modulator array;

FIG. 23A is an explanatory view of an operational principle of the GLV element;

FIG. 23B is an explanatory view of an operational principle of the GLV element;

FIG. 24 is a perspective view of a variant example of the optical modeling device according to the fourth embodiment of the present invention;

FIG. 25 is a perspective view of a schematic structure of an optical modeling device according to a fifth embodiment of the present invention;

FIG. 26 is a perspective view of a variant example of the optical modeling device according to the fifth embodiment of the present invention;

FIG. 27 is a plan view of an example of a coherent spatial light modulator;

FIG. 28 is a cross-sectional view taken along line A-A in FIG. 27.

FIG. 29A is an explanatory view of an operational state of the coherent spatial light modulator of FIG. 27;

FIG. 29B is an explanatory view of an operational state of the coherent spatial light modulator of FIG. 27;

FIG. 30 is a schematic cross-sectional view of an example of a total reflective spatial light modulator;

FIG. 31 is an explanatory view of an operational state of the total reflective spatial light modulator of FIG. 30;

FIG. 32 is a perspective view of a structure of a conventional laser scanning type optical scanning device; and

FIG. 33 is a perspective view of a structure of a conventional movable mirror type optical scanning device.

### DETAILED DESCRIPTION OF THE PREFERRED EMBODIMENT

With reference to the drawings, a detailed description of embodiments of the present invention will be given hereinafter.

First Embodiment

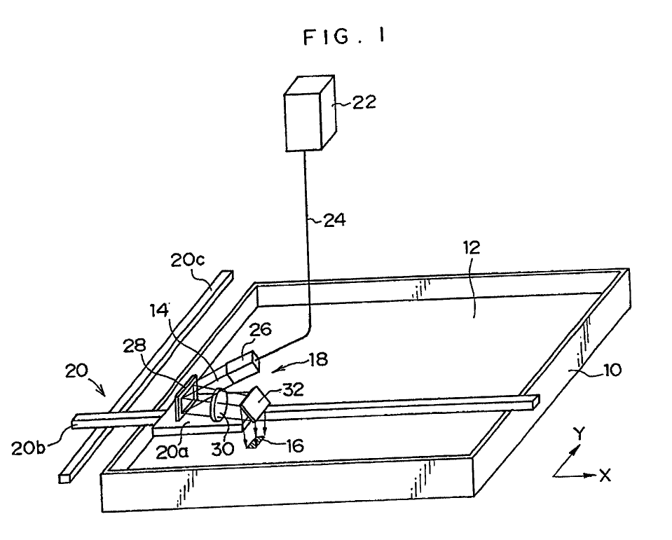

As shown in FIG. 1, an optical modeling device according to a first embodiment of the present invention comprises a container 10 which is opened at the upper portion thereof and which contains therein a liquid type photo-curable resin 12. An exposure unit 18, which exposes a region 16 having a predetermined area and including a plurality of pixels on a resin surface with a light beam 14, is disposed above the surface of the photo-curable resin 12 contained in the container 10. The exposure unit 18 is made movable in a horizontal direction (XY direction) of the resin surface by an XY positioning mechanism 20.

The XY positioning mechanism 20 comprises a base 20a for securing the exposure unit 18 thereto, a support 20b for supporting the base 20a movably in X direction, and a support 20c for supporting the support 20b, and the base 20a movably in Y direction. Then, the base 20a is slidably moved on the support 20b in X direction, the exposure unit 18 is moved in X direction, and a position of the exposure unit 18 in X direction is determined. The support 20b is slidably moved on the support 20c in Y direction, the exposure unit 18 is moved in Y direction, and a position of the exposure unit 18 in Y direction is determined. As a mechanism for sliding the base 20a and the support 20b, a lack and pinion, a ball screw, or the like can be used.

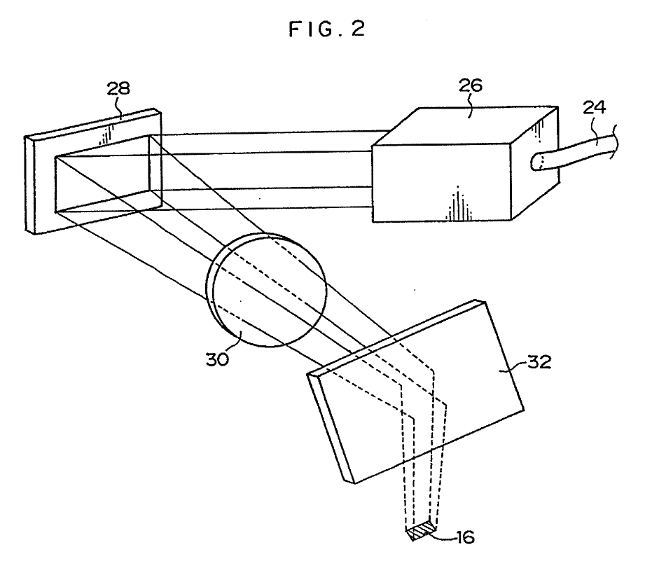

As shown in FIGS. 1 and 2, the exposure unit 18 comprises: a homogenizer optical system 26 as an arranging optical system which couples laser lights of about 0.5W emitted from a light source 22 into an optical fiber whose core diameter is 10 μm to 200 μm, in which the laser lights 14 of 50W (=0.5W×100 beams) that are transmitted through an optical fiber bundle 24 with multiple optical fibers bundled (e.g. 100 beams) are made parallel, and which arranges waveforms of the laser lights 14 and which converts intensity distribution of light within an area which is vertical to the optical axis, to a rectangular shape; and a micromirror which is arranged two-dimensionally. The exposure unit 18 further comprises: a digital micromirror device (DMD) 28 for modulating light beams emitted from the homogenizer optical system 26 for each pixel in accordance with image data of about a million pixels, for example; a condensing lens 30 for condensing the light beams emitted from the DMD 28; and a reflective mirror 32, fixedly disposed, for reflecting the light beams transmitted through the condensing lens 30 toward the surface of the photo-curable resin 12.

The XY positioning mechanism 20, the light source 22, and the DMD 28 are connected to a controller (not shown) for controlfing the same.

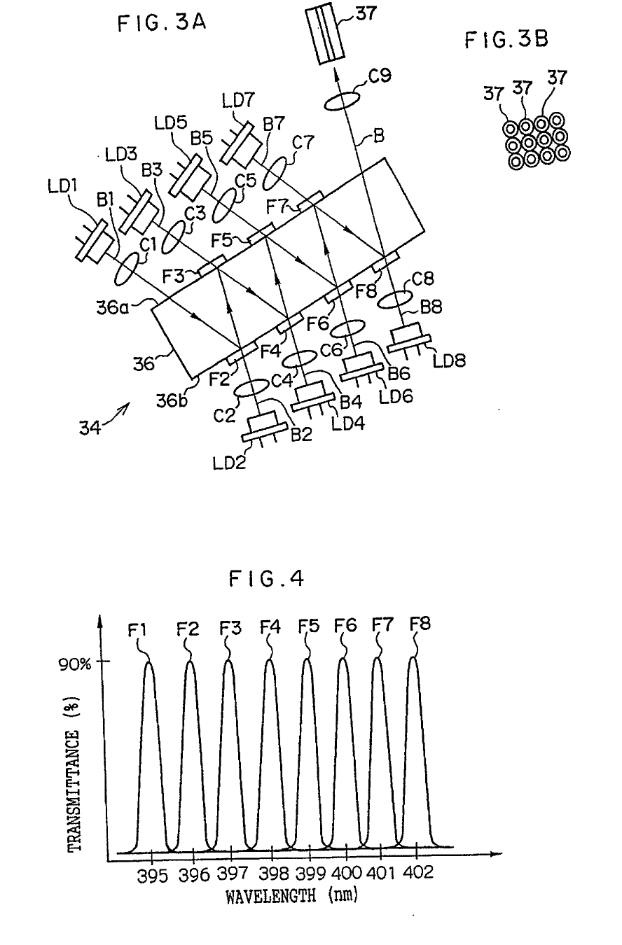

The light source 22 can use a laser light source, for example, which is disclosed in Japanese Patent Application (JP-A) No. 2001-273870 and in which mutimode gallium nitride (GaN) semiconductor lasers whose wavelengths are multiplexed to a fiber. As shown in FIG. 3A, this light source 22 comprises eight multimode gallium nitride (GaN) semiconductor lasers LD1, LD2, LD3, LD4, LD5, LD6, LD7 and LD8, and a multiplexing optical system 34. Oscillating wavelengths of the GaN semiconductor lasers LD1 to LD8 are within a range of 390 to 410 nm that enables wavelengths to oscillate and output high power, and have wavelengths of 395 nm, 396 nm, 397 nm, 398 nm, 399 nm, 400 nm, 401 nm, and 402 nm which are different from each other by 1 nm. Moreover, each laser commonly outputs 100 mW at this time.

Collimator lenses C1 to C8 are arranged so as to correspond to the GaN semiconductor lasers LD1 to LD8, and are responsible for making parallel laser beams B1 to B8 in a state of divergent lights each of which is emitted from the respective GaN semiconductor lasers LD1 to LD8.

The multiplexing optical system 34 comprises a parallel-plate prism 36, narrow band pass filters F3, F5, and F7 adhered to one surface 36a of the parallel-plate prism 36, and narrow band pass filters F2, F4, F6 and F8 adhered to the other surface of the parallel-plate prism 36. Each of the narrow band pass filter F2, F4, F6 and F8 reflects light that is emitted from an adhesive surface adhered to the surface 36a of the parallel-plate prism 36 at a reflectance of 98%, for example, and transmits light which exists within a region of a predetermined wavelength and which is emitted from the opposite side of the adhesive surface, at a transmittance of 90%. FIG. 4 shows a transmitting spectrum of the narrow band pass filters F2 to F8 in combination with a transmitting spectrum of a narrow band pass filter F1 that will be described later.

The GaN semiconductor lasers LD1 to LD8 are disposed in such a manner that the laser beams B1 to B8 emitted from GaN semiconductor lasers LD1 to LD8 enter the narrow band pass filters F2 to F8 at an incident angle of 5°, respectively. The laser beams B1 to B8 emitted from GaN semiconductor lasers LD1 to LD8 and having wavelengths of 395 nm, 396 nm, 397 nm, 398 nm, 399 nm, 400 nm, 401 nm, and 402 nm respectively enter the parallel-plate prism 36. Thereafter, the laser beams B1 to B8 are multiplexed to one single beam while being reflected by the narrow band pass filters F2 to F8, whereby the multiplexed laser beams B are emitted and the parallel-plate prism 36 can output high power (e.g. 0.5W). The emitted laser beams B are condensed by a lens C9, and coupled to multimode fibers 37 whose core diameter is about 10 μm and in which NA=0.3. As shown in FIG. 3B, the multimode fibers 37 are arranged such that end surfaces of the multimode fibers 37 into which the laser beams enters are formed in a bundle state, and output a sheet beam of 50W, for example, when 100 fibers are bundled.

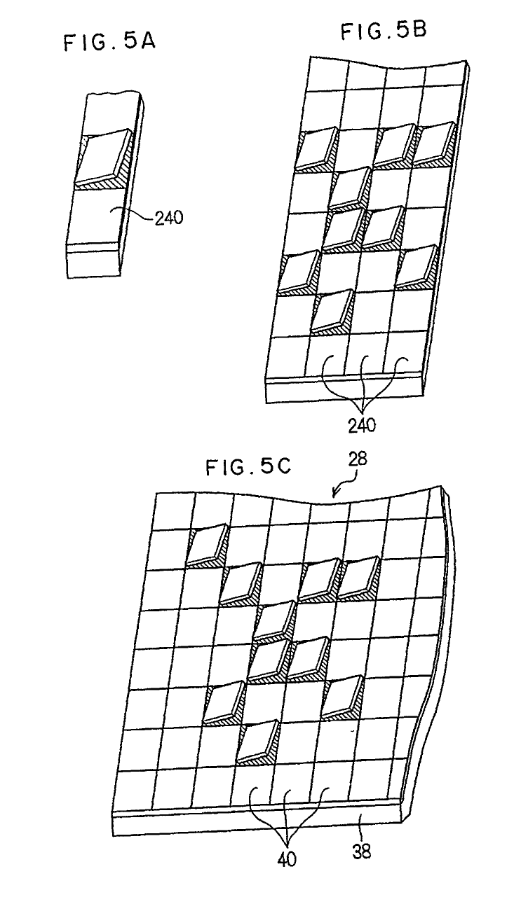

As shown in FIG. 5C, the DMD 28 is a mirror device in which fine mirrors (micromirrors) 40, which are supported by a support, are disposed on an SRAM cell (memory cell) 38, and pixels comprising multiple fine mirrors (several hundred thousands to several millions) are arranged in a lattice state. Each pixel has one micromirror 40 on top thereof which is supported by the support, and aluminum is deposited on the surface of the miromirror 40. The reflectance of the micromirror 40 is 90% or more. A silicon gate CMOS-SRAM cell 38, which is manufactured on a manufacturing line of an ordinary semiconductor memory, is disposed directly beneath the micromirror 40, through a support including a hinge and a yoke, and the entire body is formed monolithically (in one piece).

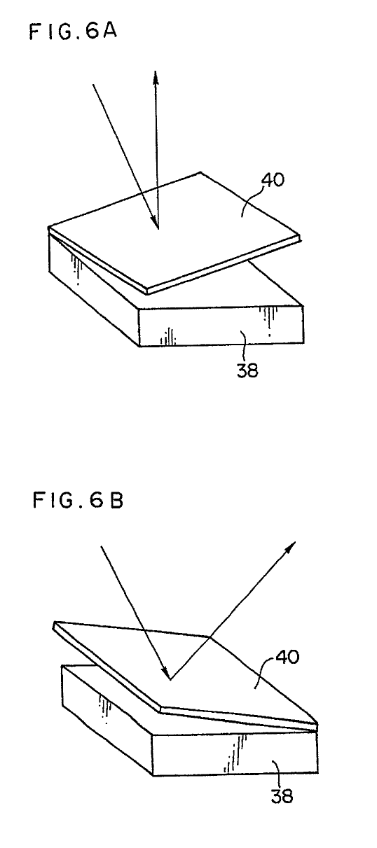

When a digital signal is written into the SRAM cell 38 of the DMD 28, each micromirror 40 supported by the support is inclined within a range of ±α° (e.g. ±10°) with respect to the substrate side at which the DMD 28 is disposed, with a diagonal line as the central axis. FIG. 6A shows on-state in which the micromirror 40 is inclines at +α°. FIG. 6B shows off-state in which the micromirror 40 inclines at −α°. Therefore, as shown in FIG. 5C, inclination of the micromirror 40 with respect to each pixel of the DMD 28 is controlled in accordance with an image signal, whereby light entering the DMD 28 is reflected in the direction in which the micromirror 40 is inclined. Moreover, FIG. 5C is a partial enlargement view of the structure of the DMD 28 in which the micromirror 40 is controlled to be angled at +α° or −α°. Each micromirror 40 is on/off controlled by a controller (not shown) connected to the DMD 28. Moreover, a light absorber (not shown) is disposed in a direction in which light beams are reflected from the micromirrors 40 in off-state.

With reference to FIG. 1, description of an operation of the optical modeling device described above will be given hereinafter. The XY positioning mechanism 20 is driven by the controller (not shown), the exposure unit 18 is moved both in directions of X and Y, and a first position of the exposure unit 18 in X and Y directions is determined. When the first position of the exposure unit 18 is determined, a light beam is emitted form the light source 22, and image data in a region 16 of a predetermined area in accordance with the first position of the exposure unit 18 is transmitted to the controller (not shown) of the DMD 28. The micromirror 40 of the DMD 28 is on/off controlled in accordance with the image data received.

The light beam 14 emitted from the light source 22 enters the homogenizer optical system 26 through the optical fiber 24 and is made parallel by the homogenizer optical system 26. The light beam 14, whose waveforms are arranged and whose intensity distribution within an area vertical to the optical axis is converted to a rectangular shape, enters the DMD 28. As shown in FIGS. 5C, 6A, and 6B, the light beam 14 emitted from the homogenizer optical system 26 enters the reflective mirror 32 when the micromirror 40 of the DMD 28 is in on-state, while the light beam 14 enters the light absorber (not shown) when the micromirror 40 is in off-state. Namely, the light beam 14 transmitted to the DMD28 is modulated for each pixel in accordance with image data. The light beam 14 enters the reflective mirror 32 and is condensed by the condensing lens 30. The condensed light beam 14 is reflected from the reflective mirror 32 and incident on the surface of the photo-curable resin 12. Accordingly, the light beam 14 exposes the interior portion of the region 16 of a predetermined area on the surface of the photo-curable resin 12, whereby the exposed portion with the light beam 14 at the interior of the region 16 is cured.

After exposure of the region 16 of a predetermined area at the first position has been completed, the exposure unit 18 is moved in the directions of X and Y, and a second position of the exposure unit 18 in the directions of X and Y is determined. In the same manner as the above-description, the region 16 of a predetermined area corresponding to the second position is exposed. Thus, due to a repetition of movement/exposure of the exposure unit 18, the entire surface of the photo-curable resin 12 can be exposed.

When a spot diameter of the light beam on the surface of the photo-curable resin 12 is 50 μm, if the exposure unit 18 comprising the DMD 28 of one million (1000×1000) pixels is used, the region 16 having an area (50 mm×50 mm) can be exposed at one time. In this case, when the total exposure area of the surface of the photo-curable resin 12 is 500 mm×500 mm, the resin surface is exposed 100 times by shifting the position of the exposure unit 18, whereby the entire resin surface can be exposed.

As described above, since the exposure unit in the optical modeling device of the first embodiment of the present invention has the DMD, the region of a predetermined area can be exposed at one time, modeling at high speed is enabled. Further, since the exposure unit is movable by the XY positioning mechanism, the entire resin surface can be exposed a plurality of times by shifting the position of the exposure unit. Because the area of the region to be exposed at one time by one single exposure unit can be limited, spatial resolution can be improved, and optical modeling with high accuracy is made possible.

The light source comprising a plurality of the GaN semiconductor lasers and the multiplexing optical system can output a high power and can be manufactured inexpensively, whereby the manufacturing cost of the entire optical modeling device can be reduced. Particularly, such light source is advantageous in that the device can be manufactured inexpensively, the maintenance thereof is facilitated, and the entire device can be made compact, when compared to a conventional optical modeling device using gas laser such as argon laser, or solid laser.

The light source is disposed outside the exposure unit, and the exposure unit and the light source are coupled by the optical fiber, resulting in a lighter weight of the exposure unit, reduction of the load applied to the XY positioning mechanism, and high-speed movement of the exposure unit.

In the above-description, an example in which the light source is a laser light source in which the GaN semiconductors are multiplexed to a fiber has been explained. However, the light source can be structured by any one of (1) to (6):

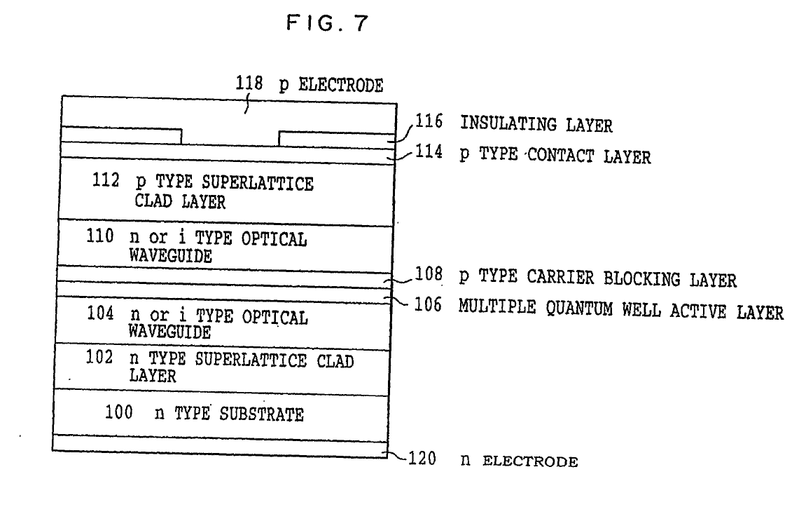

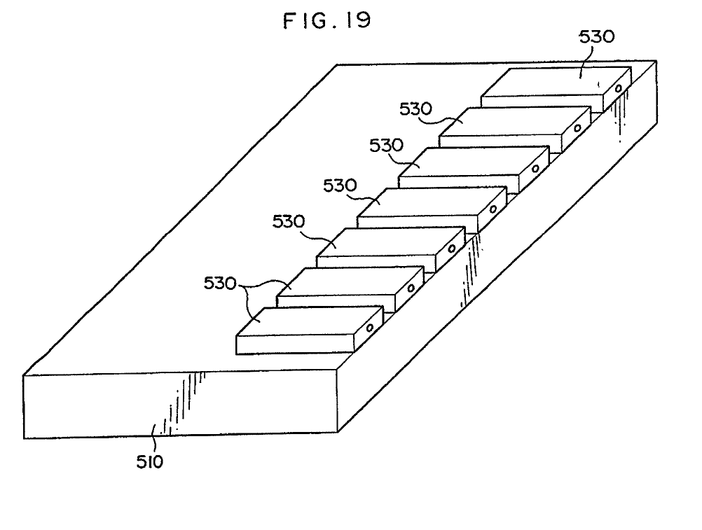

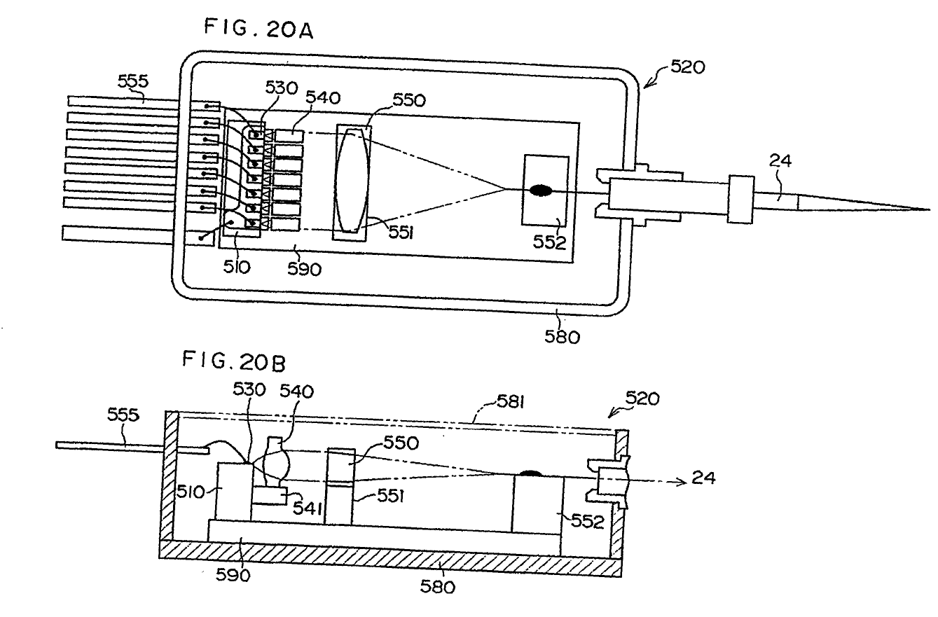

(1) A gallium nitride semiconductor laser shown in FIG. 7, preferably, an array type semiconductor laser shown in FIGS. 19 and 20 and structured by a plurality of the gallium nitride semiconductor lasers;

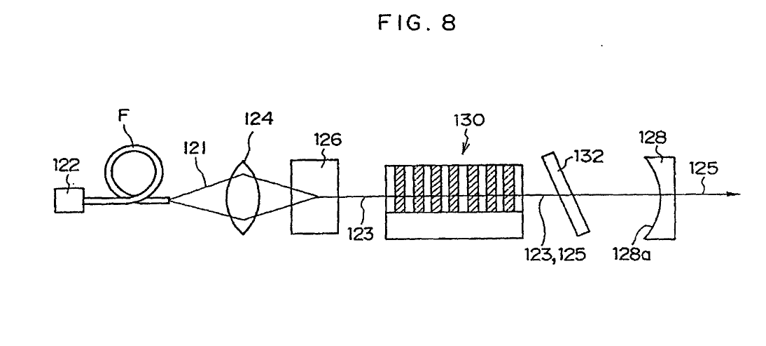

(2) A semiconductor laser excitation solid laser shown in FIG. 8, in which a laser beam caused by excitation of a solid laser crystal by the gallium nitride semiconductor laser is wavelength-converted by an optical wavelength-converting element, and emitted;

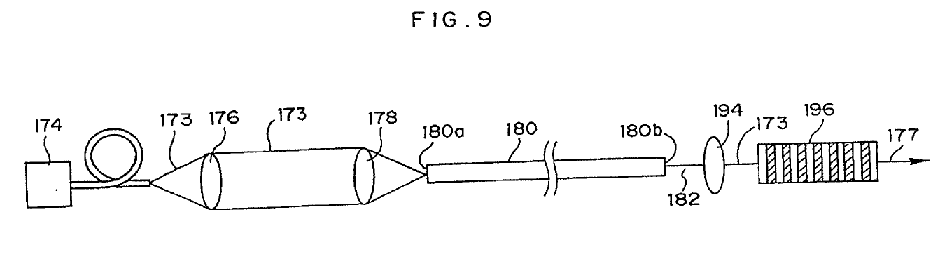

(3) A fiber laser shown in FIG. 9, in which a laser beam caused by excitation of a fiber by the gallium nitride semiconductor laser is wavelength-converted by the optical wavelength-converting element, and emitted;

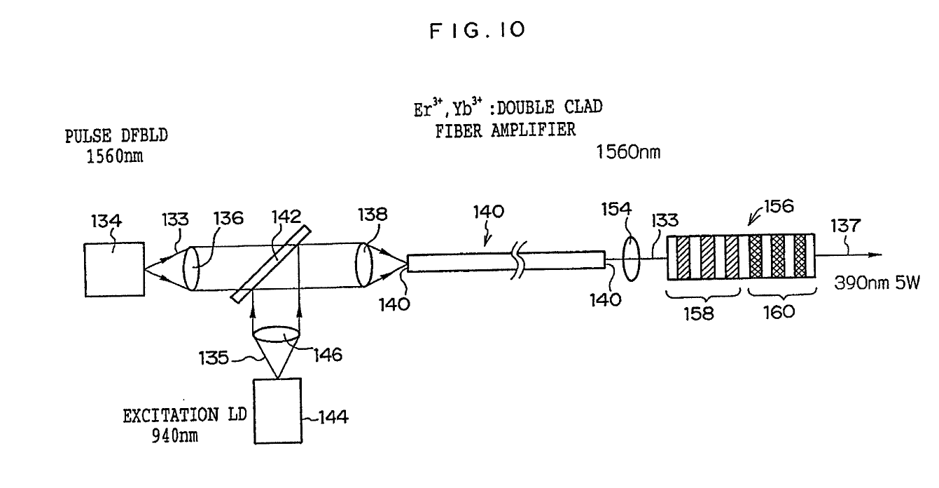

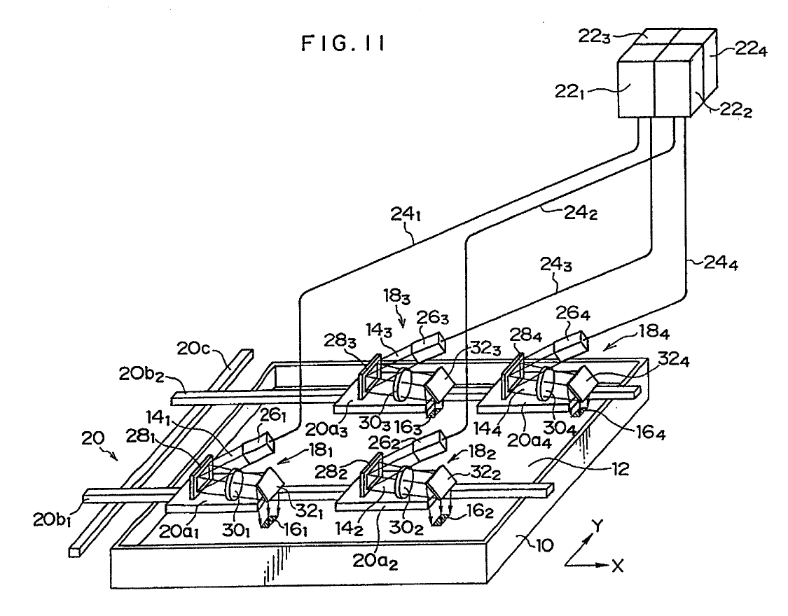

(4) A fiber laser or fiber amplifier shown in FIG. 10, in which a laser beam caused by excitation of a fiber by an infrared light-emitting semiconductor laser is wavelength-converted by the optical wavelength-converting element, and emitted;

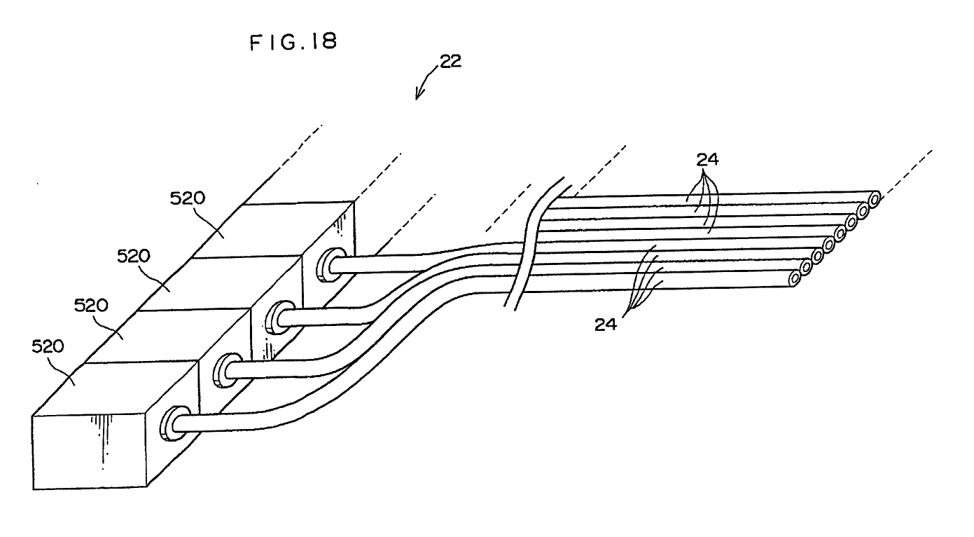

(5) Laser light sources such as a laser light source in which the gallium nitride semiconductor laser is coupled to a fiber; a laser light source in which the gallium nitride semiconductor lasers are coupled to a fiber by the multiplexing optical system; a linear laser light source in which more fibers than those shown in FIG. 18 are arranged in an array so as to emit a linear laser flux; and an area laser light source in which more fibers than those shown in FIG. 18 are arranged in a bundle so as to emit a spot type laser flux; and

(6) A laser light source comprising one of the above-described (1) to (5) laser light sources and the multiplexing optical system.

FIG. 7 shows an example of a layer structure of the (1) GaN semiconductor laser having a broad area light-emitting region. The layer-structured GaN semiconductor laser comprises an n type GaN (0001) substrate 100, sequentially on the n type GaN (0001) substrate 100, an n type Ga_{1-z1}Al_{z1}N/GaN superlattice clad layer 102 (0.05<z1<1), an n type or i type GaN optical waveguide layer 104, an In_{1-z2}Gal_{z2}N(Si doped)/In_{1-z3}Gal_{z3}N multiple quantum well active layer 106 (0.01<z2<0.05, 0.1<z3<0.3), a p type Ga_{0.8}Al_{0.2}N carrier blocking layer 108, an n type or i type GaN optical waveguide layer 110, a p type Ga_{1-z1}Al_{z1}N/GaN superlattice clad layer 112, and a p type GaN contact layer 114. An insulating film 116 is formed on the p type GaN contact layer 114 at a region excluding a stripe portion having about 50 μm width and having a p-electrode 118 formed thereon. An n-electrode 120 is formed at a rear surface of the n type GaN (0001) substrate 100. Further, since an oscillating wavelength region of this semiconductor laser is 440 nm and a light emitting region width is 50 μm, a power of about 1W is outputted, and an electricity-light conversion rate is 15%. A laser light comprising ten elements from the semiconductor laser is inputted to a fiber whose core diameter is 500 μm to thereby obtain a fiber excitation module 122 outputting a power of 10W.

FIG. 8 shows an example of a semiconductor laser excitation solid laser in which a laser beam caused by excitation of a solid laser crystal by using the (2) gallium nitride semiconductor lasers is wavelength-converted by the optical wavelength-converting element, and emitted. This semiconductor laser excitation solid laser comprises an excitation module 122 which emits a laser beam 121 as an excitation light, a fiber F whose irradiated end is optically coupled to the excitation module 122, a condensing lens 124 which condenses the laser beam 121 as a divergent light which is emitted from the fiber F, an LiYF₄ crystal 126 which is a Pr³⁺ doped solid laser medium (hereinafter, a Pr:YLF crystal), a resonator mirror 128 which is disposed at the light emitting side of the Pr:YLF crystal, an optical wavelength-converting element 130 which is disposed between the Pr:YLF crystal 126 and the resonator mirror 128, and etalon 132.

The optical wavelength-converting element 130 is structured such that a periodic domain-inverting structure is provided at an MgO-doped LiNbO₃ crystal which is a non-linear optical material. For example, when a fundamental wavelength is 720 nm and a wavelength of second harmonics is 360 nm, a period of the periodic domain inverting structure is 1.65 μm such that the period becomes a primary period relative to these wavelengths. Further, the etalon 132 as a wavelength-selecting element allows a solid laser to oscillate in a single vertical mode thus enabling noise reduction.

For example, the semiconductor laser 122 can use one of a broad area type which has an InGaN active layer and which oscillates at a wavelength of 450 nm. An end surface 126a at the light incident side of the Pr:YLF crystal 126 is coated so as to effectively transmit light of a wavelength of 450 nm therethrough at a transmittance of 80% or more. The coating reflects light of a wavelength of 720 nm that is one of the Pr³⁺ oscillating lines at a high reflectance while reflecting light of wavelengths 400 to 650 and 800 nm or more that are the other Pr³⁺ oscillating lines at a low reflectance. Further, an end surface 126b of the Pr:YLF crystal 126 is coated so as to reflect light of a wavelength 720 nm at a low reflectance while reflecting light of second harmonics with a wavelength 360 nm at a high reflectance. Further, a mirror surface 128a of the resonator mirror 128 is coated so as to reflect light of a wavelength 720 nm at a high reflectance, transmit light of a wavelength 360 nm therethrough at a transmittance of 95% or more, and reflect light of the aforementioned wavelengths 400 to 650 nm and 800 nm or more at a low reflectance.

In the semiconductor laser excitation solid laser, the laser beam 121 of a wavelength 450 nm emitted from the semiconductor laser 122 enteres the Pr:YLF crystal 126 through the end surface 126a. Pr³⁺ of the Pr:YLF crystal 126 is excited by the laser beam 121 to emit light of a wavelength 720 nm. The level transition of the Pr:YLF crystal 126 at this time is considered to be ³P₀→³F₄. A resonator comprising the end surface 126a of the Pr:YLF crystal 126 and the mirror surface 128a of the resonator mirror 128 triggers laser oscillation, and outputs a solid laser beam 123 of a wavelength 720 nm. The laser beam 123 enters the optical wavelength-converting element 130, and is wavelength-converted to a second harmonics 125 of a wavelength ½ i.e., 360 nm. Since the mirror surface 128a of the resonator mirror 128 is coated as described above, the resonator mirror 128 emits only the second harmonics 125 of about a wavelength 360 nm.

FIG. 10 shows an example of the (4) fiber laser in which a laser beam obtained by exciting a fiber by an infrared light-emitting semiconductor laser, is wavelength-converted by the optical wavelength-converting element, and emitted. This fiber laser is a THG (third harmonics) fiber laser, and comprises a pulse distribution feedback semiconductor laser (pulse DFB laser) 134 for emitting a laser beam 133 of a wavelength 1560 nm, a collimator lens 136 for making the laser beam 133 as a divergent light parallel, a condensing lens 138 for condensing the laser beam 133 made parallel, a half mirror 142 which is arranged between the collimator lens 136 and the condensing lens 138, a fiber 140 whose core is Er³⁺ and Yb³⁺ doped, a condensing lens 154 for condensing the laser beam 133 emitted from the fiber 140, and a wavelength-converting portion 156 which receives and converts the condensed laser beam 133 to a wavelength-converted wave.

The wavelength-converting portion 156 comprises an SHG (second harmonics generating) element 158 for converting the laser beam 133 to ½ of a wavelength (i.e., 780 nm), an FHG (fourth harmonics generating) element 160 for converting the laser beam 133 to ¼ of a wavelength (i.e., 390 nm). The SHG element 156 and the THG element 158 are bulk type wavelength-converting crystals which are non-linear optical materials, and in which a periodic domain inverting structure is provided at the MgO-doped LiNbO₃.

A semiconductor laser 144 emitting a laser beam 135 of a wavelength 940 nm is arranged at a reflective light incident side of the half mirror 142 (beneath the half mirror 142 in FIG. 10). A collimator lens 146 is arranged between the half mirror 142 and the semiconductor laser 144.

As shown in FIG. 10, in the fiber 140, upon receiving energy from a fluorescence of the same wavelength 1560 nm, the laser beam 133 is amplified, and then emitted from a light emitting end surface 140b of the fiber 140. The emitted laser beam 133 of a wavelength 1560 nm is condensed by the condensing lens 154, and enters the wavelength-converting portion 156. At the wavelength-converting portion 156, the laser beam 133 is wavelength-converted to a laser beam 137 of a wavelength 390 nm as a fourth harmonics, and then emitted. Further, the FHG fiber laser can output a power of 5 W.

The wavelength-converting portion is structured by an SHG (second harmonics generating) element for converting the received laser beam to a laser beam of ½ wavelength, and a THG (third harmonics generating) element for converting the received laser beam to a laser beam of. ⅓ wavelength to form a THG (third harmonics generating) fiber laser.

FIG. 9 shows an example of a fiber laser in which a laser beam is obtained by exciting a fiber by an inputting excitation module using the gallium nitride semiconductor laser of the (3), the laser beam thus obtained is wavelength-converted by an optical wavelength-converting element, and emitted. This fiber laser is an SHG (second harmonics generating) fiber laser, and comprises: a fiber inputting excitation module 174 using a GaN semiconductor laser for emitting a laser beam 173 of a wavelength 450 nm; a collimator lens 176 for making parallel the laser beam 173 which is a divergent light, a condensing lens 178 for condensing the laser beam which is made parallel; a fiber 180 whose core is Pr³⁺ doped; a condensing lens 194 for condensing a laser beam 18 of a wavelength 720 nm which is emitted from the fiber 180; and an SHG (second harmonics generating) element 196 for receiving the condensed laser beam 182 and converting to a laser beam 177 of ½ wavelength (360 nm). The SHG element 196 is a bulk type wavelength-converting crystal having a structure in which the MgO-doped LiNbO₃ comprises a periodic domain inverting structure. End surfaces 180a and 180b of the fiber 180 is coated with the characteristics of becoming AR (areflexia) to light of each of the wavelengths described above.

In this fiber laser, the laser beam 173 of a wavelength 450 μm, which is emitted from the fiber inputting excitation module 174 using the GaN semiconductor laser, is condensed by the condensing lens 178, and enters the fiber 180. A fluorescence of a wavelength 720 nm is generated by the received laser beam 173, and the fluorescence is resonated between the end surfaces 180a and 180b, whereby the laser beam 182 of a wavelength 720 nm is emitted from the emitting end surface 180b. The emitted laser beam 182 of a wavelength 720 nm is condensed by the condensing lens 194, and enters an SHG element 196. At the SHG element 196, the received laser beam 182 is wavelength-converted to the laser beam 177 of a wavelength 360 nm that is a second harmonics, and then emitted.

A light source can use a laser light including UV that is continuously driven or pulse-driven within a region of a predetermined wavelength. If the pulse-driven laser light is used as a light source, a driving electric current is pulse-driven by pulse-operating a gallium nitride semiconductor laser whose COD level is high, or a solid laser or a fiber laser is pulse-driven by a mode lock operation at a high repetitive frequency (e.g., 100 MHz). By using a pulse-driven laser light as a light source, thermal diffusion is prevented, thus making optical modeling at high speed and with high accuracy possible. Therefore, the shorter the pulse width when a laser light is pulse-driven the more acceptable. Namely, a suitable pulse width is preferably 1 psec to 100 nsec, and more preferably 1 psec to 300 psec. Specifically, formation of the pulse width of 1 psec to 300 psec is facilitated at GaN-LD whose COD is high, and also facilitated by performing a mode lock operation on the solid laser and the fiber laser which have been described in the present embodiment and which contain rare-earth elements such as Pr³⁺, Er^{3+, and Yb}³⁺ whose light emitting spectrum is broad.

Second Embodiment

As shown in FIG. 11, since an optical modeling device according to a second embodiment of the present invention is structured in the same manner as that of the first embodiment of the present invention except that the device comprises a plurality of exposure units and a plurality of light sources, portions identical to those of the first embodiment of the present invention are denoted by the same reference numerals, and a description thereof is omitted.

In the optical modeling device, four exposure units 18₁, 18₂, 18₃, and 18₄ are disposed above the surface of the photo-curable resin 12 accommodated in the container 10. The XY positioning mechanism 20 can move the exposure units 18₁, 18₂, 18₃, and 18₄, independently from each other, in horizontal (XY) directions of the resin surface.

The XY positioning mechanism 20 comprises bases 20a₁ to 20a₄ for fixing the exposure units 18₁ to 18₄ thereto, a support 20b₁ for supporting the bases 20a₁ and 20a₂ movably in X direction, a support 20b₂ for supporting the bases 20a₃ and 20a₄ movably in X direction, and a support 20c for supporting the supports 20b₁ and 20b₂, together with the bases 20a₁ to 20a₄, movably in Y direction.

The exposure units 18₁ to 18₄ respectively comprise: homogenizer optical systems 26₁ to 26₄ as arranging optical systems in which light beams 14₁ to 14₄ emitted, through corresponding optical fibers 24₁ to 24₄, from corresponding light sources 22₁ to 22₄ are made parallel, wavelengths of the light beams 14₁ to 14₄ are arranged, and intensity distribution within an area which is vertical to the optical axis of each of the light beams 14₁ to 14₄ is converted to a rectangular shape; digital micromirror devices (DMDs) 28₁ to 28₄ in which the light beams emitted from the respective homogenizer optical systems 26₁ to 26₄ are modulated for each pixel in accordance with image data; condensing lenses 30₁ to 30₄ for condensing the light beams emitted from the DMDs 28₁ to 28₄; and reflective mirrors 32₁ to 32₄, fixedly disposed, and for reflecting the light beams transmitted through the condensing lenses 30₁ to 30₄ toward the surface of the photo-curable resin 12.

The XY positioning mechanism 20, the light sources 22₁ to 22₄, and the DMD 28₁ to 28₄ are connected to a controller (not shown) for controlling the same.

Description of an operation of the optical modeling device described above will be given hereinafter. The XY positioning mechanism 20 is driven by an unillustrated controller, each of the exposure units 18₁ to 18₄ is moved in the directions of X and Y, whereby the first position of each of the exposure unit 18₁ to 18₄ in the directions of X and Y is determined. When the first position of each of the exposure units 18₁ to 18₄ in the directions of X and Y is determined, in the same manner as in the first embodiment of the present invention, the regions 16₁ to 16₄ each having a predetermined area of the surface of the photo-curable resin 12 are exposed by the corresponding light beams 14₁ to 14₄, and the exposed portions with the light beams within the regions 14₁ to 14₄ are cured.

When exposure of each of the regions 14₁ to 14₄ having a predetermined area has been completed at the first position, the XY positioning mechanism 20 moves each of the exposure units 18₁ to 18₄ in the directions of X and Y, a second position of each of the exposure units 18₁ to 18₄ in X and Y directions is determined, and in the same manner as the above-description, the regions 16₁ to 16₄ corresponding to the second positions of the exposure units 18₁ to 18₄ are exposed. Thus, due to the repetition of movement/exposure of the exposure units 18₁ to 18₄, the entire surface of the photo-curable resin 12 can be exposed.

As described above, in the second embodiment of the present invention, the optical modeling device comprises a plurality of the exposure units having the DMDs, and each of the exposure units can expose a region of a predetermined area at one time. Accordingly, the device can carry out optical modeling at further higher speed than that in the first embodiment of the present invention. For example, if the device uses four exposure units, the device can perform optical modeling four times quicker than that using one exposure unit.

If a plurality of the exposure units is used for exposure, each of the regions to be exposed by the exposure units is decentralized and cured, whereby occurrence of distortions due to localized curing and/or contraction of the regions to be exposed can be inhibited. Besides, even when one of the exposure units is out of order, another exposure unit can continue optical modeling, whereby usage stability of the device can be improved.

In the second embodiment of the present invention, an example in which the device comprises four exposure units has been described. However, the number of the exposure units is appropriately determined on the basis of a size of a container for accommodating the photo-curable resin, a desired modeling speed, a modeling accuracy, and the like. Further, in the same manner as the first embodiment of the present invention, the light source can be structured by any one of the (1) to (6).

Third Embodiment

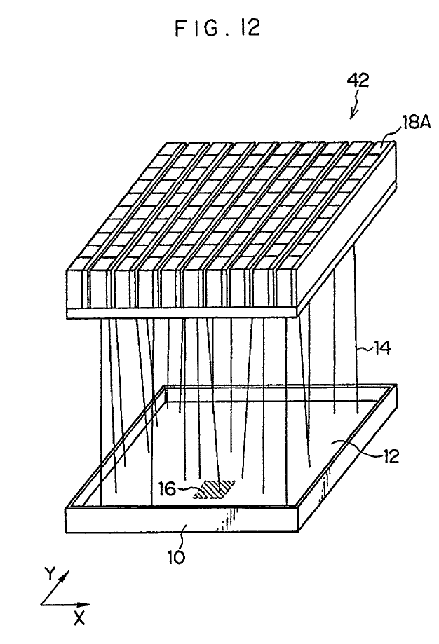

An optical modeling device according to a third embodiment of the present invention comprises a container 10 having an open top. The container 10 accommodates the photo-curable resin 12. An exposure head 42 is fixed by a fixing portion (not shown) and disposed above the surface of the photo-curable resin 12 accommodated in the container 10. The exposure head 42 has a number of exposure units 18A (100 in FIG. 12), arranged in an array (10 rows×10 columns), for scanning and exposing the region of a predetermined area including multiple pixels on the resin surface with the light beam 14.

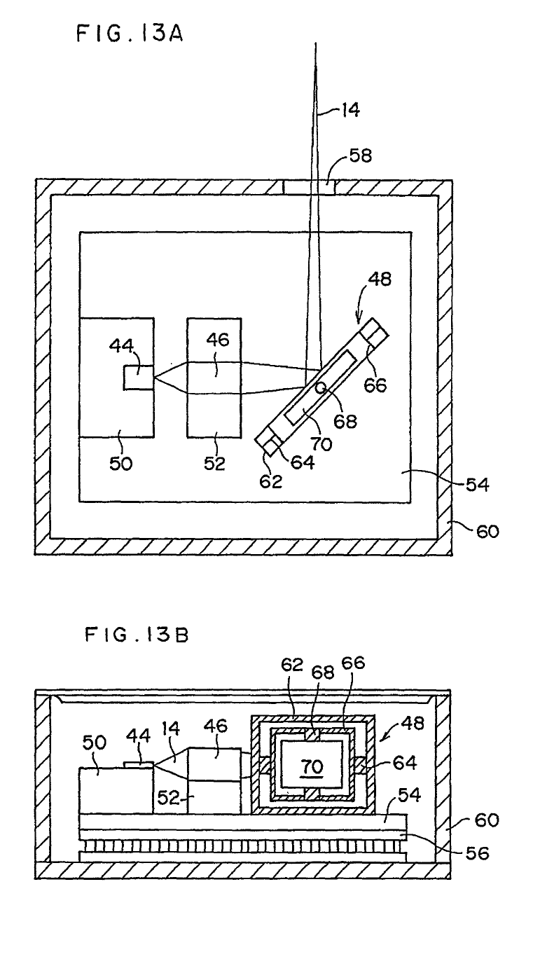

As shown in FIGS. 13A and 13B, the exposure unit 18A comprises: a GaN semiconductor laser 44 as a light source; a condensing lens 46 comprising, for example, a refractive index distributing lens for condensing a light beam emitted from the GaN semiconductor laser 44, and a two-dimensional microscanner 48 for reflecting the light beam condensed by the condensing lens 46 in a two-dimensional direction and focusing the light beam on the surface of the photo-curable resin 12.

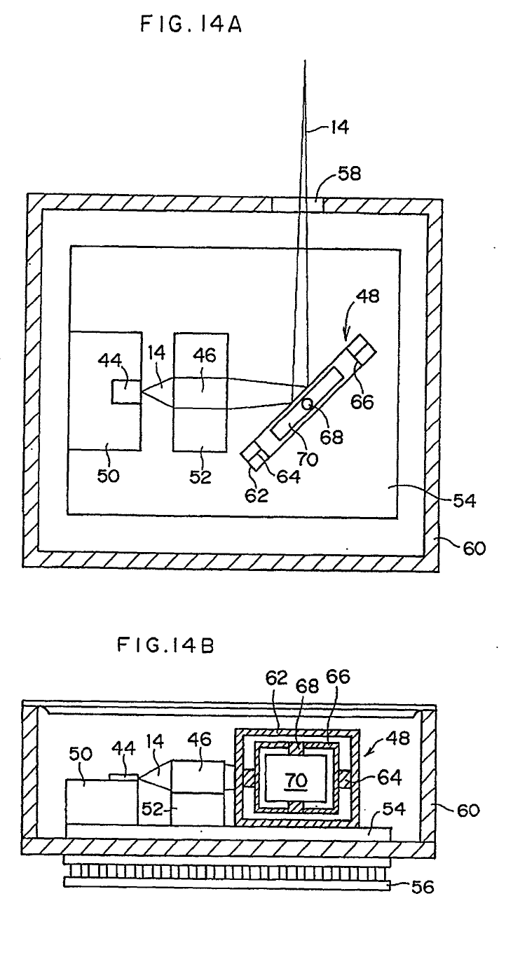

The GaN semiconductor laser 44 and the condensing lens 46 in a state of being held by mounts 50 and 52 comprising copper or silicon, for example, and the two-dimensional microscanner 48 are respectively mounted to a common substrate 54. The substrate 54 having respective structural components fixedly arranged thereon is fixed to a Peltier element 56 which comprises a temperature adjusting portion, and hermetically enclosed inside a package 60 having a light emitting window 58. A thermistor (not shown) is mounted to the interior of the package 60, and the driving of the Peltier element 56 is controlled by temperature control circuits (not shown) of the thermistor on the basis of temperature detection signals outputted from the thermistor, whereby the whole elements within the package 60 are adjusted to a common predetermined temperature. Moreover, as shown in FIGS. 14A and 14B, the Peltier elements 56 may be provided outside the package 60.

The two-dimensional scanner 48 comprises an outer frame 62 which is fixed to the substrate 54, an inner frame 66 which is held at the outer frame 62 so as to rotate around a rotational axis 64, and a reflective mirror 70 which is held at the inner frame 66 so as to rotate around a rotational axis 68. Each of the exposure units 18A is disposed at the exposure head 42 to scan the region 16 of the resin surface in the directions of X and Y with the light beam reflected from this reflective mirror 70.

The GaN semiconductor laser 44 and the two-dimensional microscanner 48 of one exposure unit 18A are connected to the controller (not shown) for controlling those independently of each other.

Description of an operation of the optical modeling device described above will be given hereinafter. The GaN semiconductor laser 44 of one exposure units 18A is driven independently by the controller (not shown), a light beam is emitted from the GaN semiconductor laser 44, and image data from the region 16 of a predetermined area in accordance with a position at which each exposure unit 18A is arranged is transmitted to the controller (not shown) of the two-dimensional microscanner 48. In the two dimensional microscanner 48, in accordance with image data, the reflective mirror 70 which is held at the inner frame 66 is rotated around the rotational axis 68 to scan the light beam 14 in X direction, and the inner frame 66 which is held at the outer frame 62 is rotated around the rotational axis 64 in cooperation with the reflective mirror 70 to scan the light beam 14 in Y direction orthogonal to X direction and expose the region 16 of a predetermined area corresponding to each exposure unit 18A. Consequently, the entire surface of the photo-curable resin 12 is exposed.

For example, when the spot diameter of the light beam on the surface of the photo-curable resin 12 is 50 μm, if the exposure unit 18A having the two-dimensional scanner 48 comprising one million pixels (1000×1000) is used, the region 16 of an area 50 mm×50 mm can be exposed at one time. In this case, when the total exposure area of the surface of the photo-curable resin 12 is 500 mm×500 mm, 100 sets of the exposure units 18A are used to expose the surface of the photo-curable resin 12 at one time, whereby the entire surface can be exposed in a short time. Namely, a region to be exposed per one exposure unit when the entire surface is exposed at one time by using 100 sets of the exposure units 18A equals to 1/100 of a region to be exposed when the entire surface is exposed by one single exposure unit 18A, whereby the exposure time can be reduced.

As described above, in the optical modeling device according to the present invention, since the exposure unit uses a two-dimensional scanner which scans the resin surface by using a light beam modulated for each pixel in accordance with image data, the exposure unit can be made compact as compared to a conventional case of using two sets of movable mirrors. For this reason, multiple exposure units can be arranged on an exposure head, a region of a predetermined area can be scanned and exposed in parallel by multiple exposure units, whereby modeling at high speed and with high accuracy is made possible. Further, since the entire resin surface is exposed by lots of exposure units, it is possible to limit the area of a region that is supposed to be scanned and exposed by one single exposure unit. For example, with the use of 100 sets of the exposure units, pincushion errors can be reduced to about 1/10 of those with the use of one single exposure unit.

The light source comprising the GaN semiconductor laser can output high power and can be manufactured inexpensively, thus allowing the entire optical modeling device to be manufactured at less expense. Particularly, as compared to a conventional optical modeling device. using gas laser such as argon laser or solid laser, the present invention is advantageous in that the device can be manufactured inexpensively and the maintenance is facilitated, and the entire device can be made compact.

In the third embodiment of the present invention, an example in which 100 sets of the exposure units are provided has been explained. However, the number of the exposure units can appropriately be determined in accordance with the size of a container for accommodating the photo-curable resin, a desired modeling speed, a modeling accuracy, and the like. The number of the exposure units is preferably from 25 to 100.

Further, in the third embodiment of the present invention, an example in which the light source comprises the GaN semiconductor laser has been explained. However, the light source can comprise any one of (1) to (6).

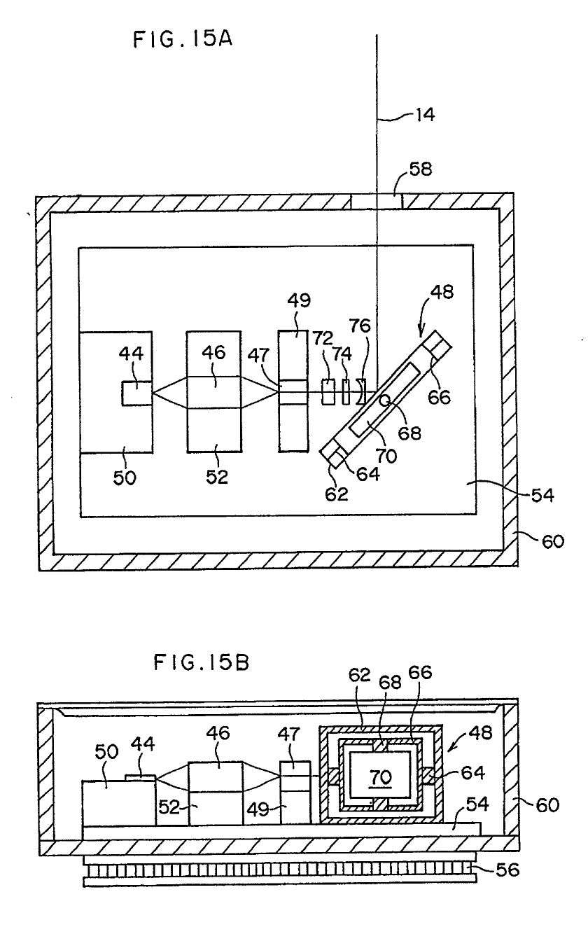

FIGS. 15A and 15B show a structural example of an exposure unit using the above described (2) semiconductor laser excitation solid laser. Portions identical to those of the third embodiment of the present invention are denoted by the same reference numerals, and a description thereof is omitted. In this exposure unit, an LiYF₄ crystal 47, which is a Pr³⁺ doped solid laser medium (hereinafter, a Pr:YLF crystal), is disposed between the condensing lens 46 and the two-dimensional microscanner 48, and mounted to the common substrate 54 in a state of being held by a mount 49 comprising copper, for example. Further, a wavelength-converting element 72, etalon 74, and a resonator mirror 76 are disposed in this order between the Pr:YLF crystal 47 and the two-dimensional microscanner 48 in a state of being held by a mount (not shown). Further, the Pertier element 56 is provided outside the package 60. Moreover, the optical wavelength-converting element 72, the semiconductor laser 44, and the resonator mirror 76 are structured in the same manner as the semiconductor laser excitation solid laser shown in FIG. 8.

In the semiconductor laser excitation solid laser, Pr³⁺ of the Pr:YLF crystal 47 is excited by the laser beam emitted from the semiconductor laser 44, and a laser beam of a predetermined wavelength is emitted from the Pr:YLF crystal 47. The emitted laser beam is resonated by a resonator formed by an end surface of the Pr:YLF crystal 47 and a mirror surface of the resonator mirror 76, is wavelength-converted by the optical wavelength-converting element 72, and then emitted.

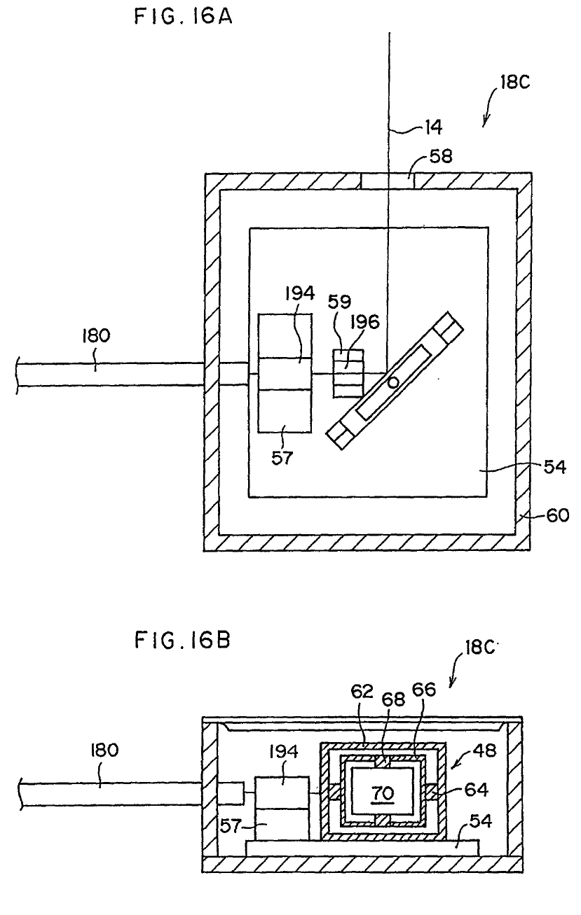

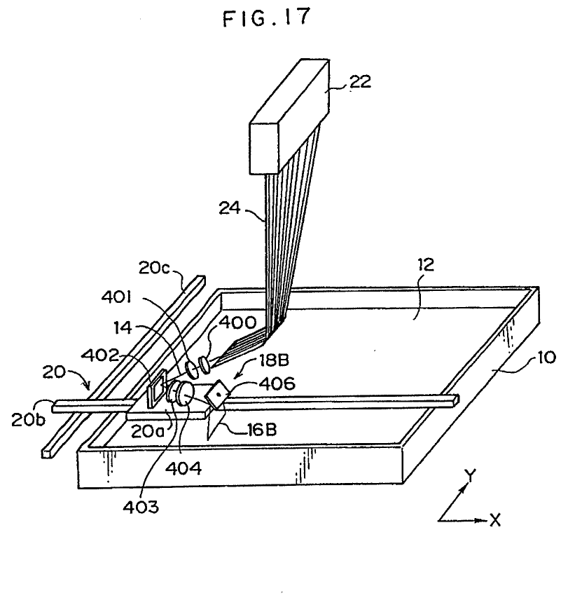

FIGS. 16A and 16B show a structural example of an exposure unit using a fiber laser in which a laser beam obtained by excitation of a fiber by the gallium nitride semiconductor laser shown in FIG. 9 is wavelength-converted by the optical wavelength-converting element, and emitted. Portions identical to those of the exposure unit in the third embodiment of the present invention are denoted by the same reference numerals and a description thereof is omitted. This exposure unit comprises a fiber laser, and a two-dimensional microscanner 48 for reflecting a light beam 177 emitted from the fiber laser in a two-dimensional direction and for focusing the light beam transmitted through a condensing lens 194 on the surface of the photo-curable resin 12.

As shown in FIG. 9, the fiber laser comprises a GaN semiconductor laser 174 for emitting a laser beam 173 of a wavelength 450 nm, a collimator lens 176 for making the laser beam 173 as a divergent light parallel, a condensing lens 178 for condensing the laser beam 173 made parallel, a fiber 180 whose core is Pr³⁺ doped, a condensing lens 194 for condensing a laser beam 182 of a wavelength 720 nm emitted from the fiber 180, and an SHG (second harmonics generating) element 196 for receiving the condensed laser beam 182 and converting the laser beam 182 to the laser beam 177 of ½ wavelength (360 nm).

The condensing lens 194 and the SHG element 196 are disposed inside the package 60. The condensing lens 194 and the SHG element 196, in a state of being held respectively at the mounts 57 and 59 which are made of copper, for example, together with the two-dimensional microscanner 48, are mounted to the common substrate 54. The substrate 54 having respective structural components disposed fixedly thereon is hermetically enclosed at the interior of the package 60 having the light emitting window 58. The light emitting side end of the fiber 180 penetrates through the side wall of the package 60, is introduced into the package 60, and is optically coupled with the condensing lens 53. On the other hand, other structural components which are not shown in FIGS. 16A and 16B but shown in FIG. 9 are provided outside the package 60.

Fourth Embodiment

As shown in FIG. 17, an optical modeling device according to a fourth embodiment of the present invention is structured in the same manner as the optical modeling device of the first embodiment of the present invention except that, instead of the exposure unit 18, an exposure unit 18B in which a segment 16B including a plurality of pixels on the resin surface is exposed at one time with the light beam 14 is disposed, and a fiber array, that is disclosed in Japanese Patent Application Laid-Open (JP-A) Nos. 2001-273870 and 2001-273871, is used for the light source 22. Therefore, portions identical to those shown in the first embodiment of the present invention are denoted by the same reference numerals, and a description thereof is omitted.

As shown in FIG. 17, the exposure unit 18B comprises: lenses 400 and 401 for irradiating the light beam 14 transmitted through the optical fibers 24 arranged in an array from the light source 22 of about 500W; a light modulator array 402 for modulating the light beam irradiated from the lens 400 for each pixel in accordance with image data; condensing lenses 403 and 404 for condensing the light beam emitted from the light modulator array 402; and a reflective mirror 406, fixedly disposed, for reflecting the light beam transmitted through the condensing lens 404 in the direction of the surface of the photo-curable resin 12.

FIG. 18 shows the light source 22 disclosed in JP-A Nos. 2001-273870 and 2001-273871 in more detail. The light source 22 comprises multiplexing modules 520 for multiplexing light beams emitted from multiple semiconductor laser chips to one single fiber, and the optical fiber 24 which is optically coupled to the multiplexing modules 520 and which is arranged in an array so as to emit a linear laser luminous flux. As shown in FIG. 19, and FIGS. 20A and 20B, each of the multiplexing modules 520 comprises: a plurality of (e.g. seven) transverse multimode gallium nitride semiconductor lasers 530 which are fixedly arranged on a heat sink block 510 (formed by copper, for example); collimator lenses 540 which are provided so as to face each of the semiconductor lasers; and a condensing lens 550. One multiplexing module 520 is optically coupled to one multimode optical fiber 24.

The heat sink block 510, the semiconductor laser 530, the collimator lens 540, and the condensing lens 550 are accommodated in a box-shaped package 580 whose upper portion is opened, and hermetically enclosed within a closed space structured by the package 580 and a package cap 581 by the opening of the package 580 closed by the package cap 581.

A base plate 590 is fixed to the bottom surface of the package 580, the heat sink block 510 is mounted on the top surface of the base plate 590, and a collimator lens holder 541 for holding the collimator lenses 540 is fixed to the heat sink block 510. Further, a condensing lens holder 551 for holding the condensing lens 550 and a fiber holder 552 for holding an incident end portion of the multimode optical fiber 24 are fixed to the top surface of the base plate 590. Wirings 555 for supplying a driving current into the gallium nitride semiconductor lasers 530 are drawn out of the package 580, through the wirings 555 which are enclosed by a hermetically sealing material (not shown) formed at a side wall surface of the package 580.

An aperture of each of the collimator lenses 540 in a direction in which the light emitting points of the gallium nitride semiconductor lasers 530 are arranged is formed smaller than that in a direction orthogonal to the direction in which the light emitting points of the gallium nitride semiconductor lasers 530 are arranged (namely, in an elongated shape), whereby the collimator lenses 540 are arranged close to the direction in which the light emitting points are arranged. Examples of the gallium nitride semiconductor lasers 530 include the ones which emit a laser beam whose light emitting width is 2 pm, and whose angles spread in a direction parallel to an active layer and in a direction orthogonal to the active layer are 10° and 30°, respectively.

Accordingly, the laser beam emitted from each light emitting point enters the collimator lens 540 such that a direction in which the spread angle of the light beam becomes maximum corresponds to a direction in which the aperture of the collimator lens 540 is the largest, and a direction in which the spread angle of the light beam becomes minimum corresponds to a direction in which the aperture of the collimator lens 540 is the smallest. Namely, the elongated shape of the collimator lens 540 can be corresponded to an elliptical cross-sectional configuration of the incident laser beam, whereby the collimator lens 540 can be used by minimizing the non-working portions thereof.

For example, in the present embodiment, the collimator lens 540 can be used in which a horizontal aperture is 1.1 mm, a vertical aperture is 4.6 mm, a focal length is 3 mm, and an NA is 0.6, and a laser beam entering the collimator lens 540 has a horizontal beam diameter of 0.9 mm, and a vertical beam diameter of 2.6 mm. Further, the collimator lenses 540 are arranged at a pitch of 1.25 mm.

The condensing lens 550 is formed in a rectangular shape whose lengthwise direction corresponds to a direction in which the collimator lenses 540 are arranged i.e., a horizontal direction, and whose widthwise direction corresponds to a direction orthogonal thereto. The condensing lens 550 having a focal length of 12.5 mm and an NA of 0.3 can be used. The condensing lens 550 is formed by molding resin or optical glass.

Examples of the multimode optical fiber 24 can include an optical fiber whose core central portion is a graded index type based on the one (manufactured by Mitsubishi Cable Industries, Ltd.) and whose outer peripheral portion is an step index type, which has a core diameter of 25 μm, an NA of 0.3, and a transmittance of end surface coating is 99.5% or more. Namely, the value of core diameter and NA is 7.5 μm.

When a coupling rate of the laser beam to the multimode optical fiber 24 is 0.9, the output of the gallium nitride semiconductor laser 530 is 100 mW, and the number of the semiconductor laser 530 is seven, multiplexed laser beam having an output of 630 mW (−100 mW×0.9×7) can be obtained.

The oscillating wavelengths of the gallium nitride semiconductor lasers 530 are 405±10 nm, and the maximum output thereof is 100 mW. The laser beams emitted from these gallium nitride semiconductor lasers 530 are made parallel by the corresponding collimator lenses 540 to the gallium nitride semiconductor lasers 530. The laser beams made parallel are condensed by the condensing lens 550, and converged onto the incident end surface of the core of the multimode optical fiber 24.

The condensing optical system is structured by the collimator lenses 540 and the condensing lens 550, and the multiplexing optical system is structured by the multimode optical fiber 24 in combination with the collimator lenses 540 and the condensing lens 550. Namely, the laser beam, which has been condensed as described above by the condensing lens 20, enters the core of the multimode optical fiber 24, propagates therethrough, is coupled with one single laser beam, and then emits from the multimode optical fiber 24. When the multimode optical fiber 24 of the step index type is used or when the multimode optical fiber 24 having a micro size core and having high NA is used, a graded index type thereof and a composite type thereof can be applied.

Instead of the respective collimator lenses 540 corresponding to each of the semiconductor lasers 530, a collimator lens array can be used which has the number of lens elements corresponding to that of the semiconductor lasers 530. The use of the collimator lens array allows for more spatial availability than that of the respective collimator lenses 540 which are arranged to be kept closely in contact with each other and in which the gallium nitride semiconductor lasers 530 are disposed at a narrow pitch. An effect can be obtained in that, due to such an increase of the spatial availability, the number of the multiplexers can be increased, and positioning accuracy with which the gallium nitride semiconductor lasers 530, the condensing optical system, and the multimode optical fiber 24 are assembled can be comparatively reduced.

A focal length and an NA (numerical aperture) of each lens element of the collimator lens array or the respective collimator lenses 540 are f₁, NA₁, a focal lens of the condensing lens 550 is f₂, an NA of the multimode optical fiber 24 is NA₂, and spatial availability is η. The spatial availability η is determined by a ratio of a space occupied by optical paths of laser beams to a space occupied by the laser beams, and a state in which the optical paths of the laser beams are kept in tight contact with one another is η=1.

Under the aforementioned conditions, a magnification α of a lens diameter i.e., a ratio of a beam spot diameter on a core end surface of the multimode fiber 24 to a beam spot diameter at each of the emitting points of the gallium nitride semiconductor lasers is represented by the following equation (1) wherein N is the number of the multiplexers:

$$a = \frac{{f}_{2}}{{f}_{1}} = \frac{N {A}_{1}}{( \frac{N {A}_{2}}{N} \times η )} = \frac{N {A}_{1}}{N {A}_{2}} \times \frac{N}{η}$$

As is apparent from the equation (1), the larger the spatial availability, the lower the magnification α. And, the smaller the magnification α, the smaller the distance laser beams move on a core end surface of the multimode optical fiber 24 when the gallium nitride semiconductor laser, the condensing optical system, and the multimode optical fiber are shifted from one another. Accordingly, the laser beams can normally enter the core of the multimode optical fiber 24 even if the gallium nitride semiconductor lasers, the condensing optical system, and the multimode optical fiber 24 are assembled with a comparatively low positioning accuracy. When η approaches 1, the magnification a decrease, whereby the number of multiplexers N can be increased by the decreased amount of a. Accordingly, even when the number of the multiplexers N is increased, laser beams can output a high power at high misregisration tolerance.

The fiber 24 provided for each of a multiple number of the semiconductor laser chips 520 is arranged in the lengthwise direction of the light modulator array 402 and formed in an array so as to irradiate a linear laser light which extends in a lengthwise direction of the light modulator array 402 which is formed into an elongated shape.

As described above, the laser lights emitted from the gallium nitride semiconductor lasers 530 are collimated by the corresponding collimator lenses 540, and then enter the optical fiber 24. If seven semiconductor lasers 530 are provided at each of the semiconductor laser chips 520, seven collimated laser lights are optically coupled to the fiber 24 by using the aspheric glass mold lens 550. When 100 fibers each having a core diameter of 25 μm, NA=0.3, and each outputting power 0.5 W are arranged, super high power linear beams of 50W (=0.5W×100) can be emitted. The linear beam is irradiated by an irradiation lens system, and enters the elongated light modulator array 402.

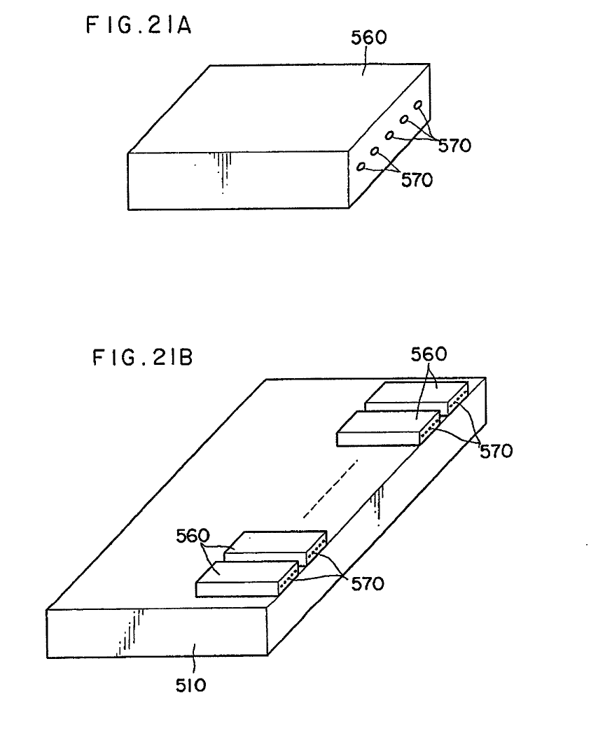

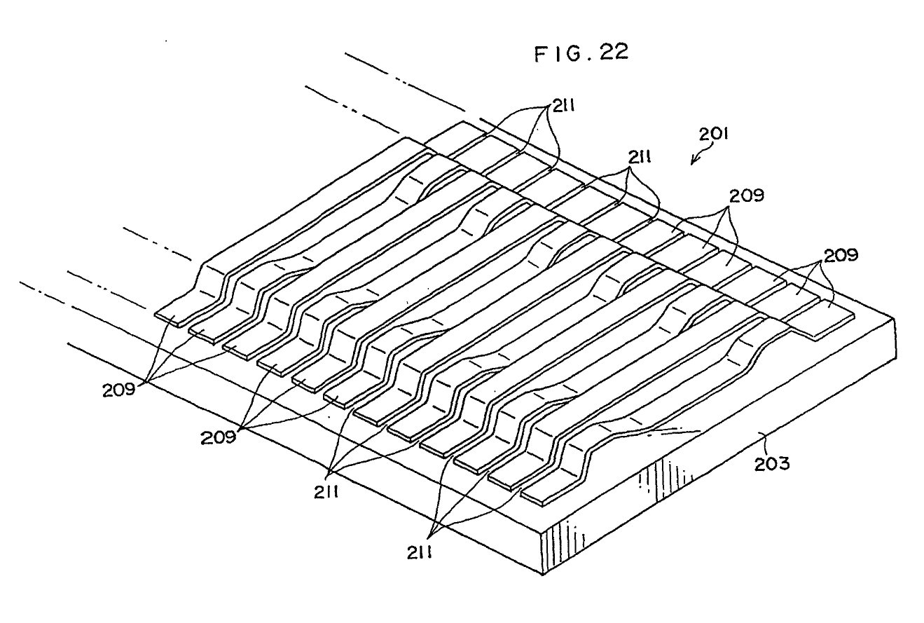

The super high power linear beams of 50W (=0.5W×100) having the aforementioned fibers arranged thereon can be replaced by an array type semiconductor laser which is disclosed in Japanese Patent Application (JP-A) Laid-Open No. 2001-273849 and in which semiconductor laser chips 560 shown in FIG. 21A are arranged in a predetermined direction as shown in FIG. 21B. The light source 22 is structured by a plurality of the semiconductor laser chips 560. Each of the semiconductor laser chips 560 comprises a plurality of light emitting points 570. If the number of the light emitting points 570 is five and each of the light emitting points 570 has an output of 0.1W, each of the semiconductor laser chips 560 has an output of 0.5W (=0.1W×5). Meanwhile, when the light source 22 comprises 34 semiconductor laser chips 560, an array beam outputting a high power of 17W (=0.5W×34) can be emitted. When three of this array beam of 17W are arranged, a high power outputting linear beam of 50W (=17W×3) which are almost the same as the beam with fibers arranged thereon can be obtained.

As shown in FIG. 17, in the exposure unit 18B, the light beam 14 is emitted from the light source 22 described above, passed through a plurality of the fibers 24 arranged linearly, and irradiated through the lenses 400 and 401 to form a segment on the light modulator array 402. The light beam that is modulated by the light modulator array 402 for each pixel in accordance with image data is reflected from the reflective mirror 406, and focused by the lenses 403 and 404 in Y direction so as to form a segment on the surface of the photo-curable resin 12.

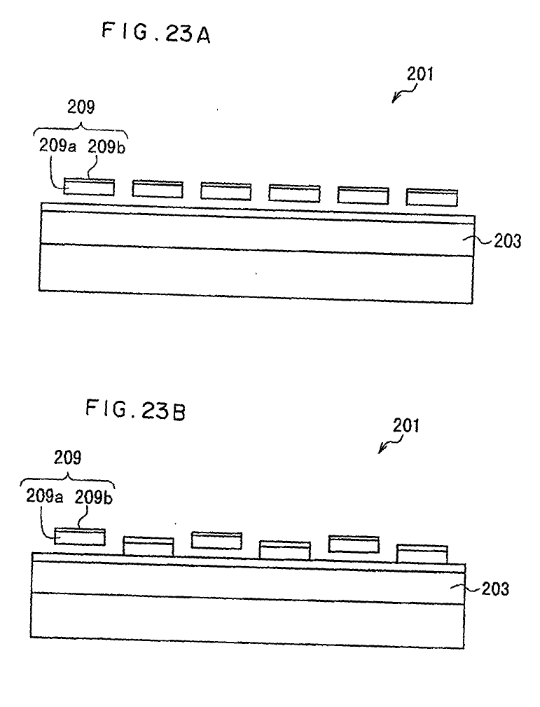

With reference to FIG. 22 and, FIGS. 23A and 23B, description of a structure and an operational principle of GLV (Grating Light Valve) elements used for the light modulator array 402 will be given hereinafter. A GLV element 201 is, for example, an MEMS (Micro Electro Mechanical Systems) type spatial light modulator (SLM) as disclosed in JP-A No. 5,311,360. As shown in FIG. 22, the GLV element 201 comprises gratings arranged in one direction.

As shown in FIG. 22, quite a few of ribbon type micro-bridges 209 (e.g. 6,480) are disposed on a substrate 203 which is made of silicon or the like, of the GLV element 201. A plurality of the micro-bridges 220 is arranged parallel to one another, whereby a plurality of slits 211 are formed. The micro-bridges 209 are provided so as to be spaced apart from the substrate 203 at a predetermined distance.

As shown in FIGS. 23A and 23B, the micro-bridge 209 at the bottom side that faces the substrate 203 is formed by a flexible beam 209a comprising SiNx or the like, while the one at the top side is formed by a reflective electrode layer 209b which is formed by a single metal layer of aluminum (or gold, silver, copper or the like). By forming the reflective electrode layer 209b by gold, silver or copper, reflectance can be improved for optical wavelengths to be used. The aforementioned substrate 203, the micro-bridges 209, and the unillustrated controller correspond to a movable grating moving portion.

This GLV element 201 is driven and controlled by switching on/off of a voltage applied between the microbridges 209 and the substrate 203. When the voltage applied between the microbridges 209 and the substrate 203 is switched on, electrostatic attraction is generated therebetween, and the microbridges 209 flex towards the substrate 203. Meanwhile, the voltage applied between the micro-bridges 209 and the substrate 203 is switched off, the state in which the microbridges 209 have been flexed is cancelled, whereby the microbridges 209 separate from the substrate 203 due to ballistic return. Ordinarily, one pixel comprises a plurality of the microbridges 209 (six, for example). The microbridges 209 to which a voltage is to be applied are alternately arranged, gratings are thereby formed at the microbridges 209 upon the application of the voltage, and light modulation is carried out.

If the voltage is not applied to the microbridges 209, the reflecting surfaces of the microbridges 209 are entirely leveled, lengths of optical paths are the same, and light beams are normally reflected. On the other hand, when a voltage is applied to every one microbridge, the central portion of the microbridge 209 to which the voltage has been applied flexes in accordance with the above-described principle, whereby levels of the reflecting surfaces of the microbridges 209 alternately change. When laser beams are irradiated on such reflecting surfaces, since lengths of the optical paths are different at the light reflected from the microbridges 209 without flexure, optical grating phenomenon is generated. Intensity I₁ₛₜ of a primary grating light depends on an optical path difference, and can be expressed by the following equation. In this ease, the intensity of grating light becomes the highest when the optical path difference is λ/2.

$${I}_{1 s t} = {I}_{max} sin ( \frac{2 π d}{λ} )$$

Description of an operation of the optical modeling device described above will be given hereinafter.

The XY positioning mechanism 20 is driven by the controller (not shown) to move the exposure unit 18B both in X direction and Y direction, whereby initial positions of the exposure unit 18B in the X direction and the Y direction are determined. When the initial positions of the exposure unit 18B is determined, a light beam is emitted from the light source 22, and image data of the segment 16B including a plurality of pixels corresponding to the initial positions of the exposure unit 18B is transmitted to the unillustrated controller of the light modulator array 402. Each of the GLV elements 201 of the light modulator array 402 is on/off controlled in accordance with the image data received, as described above.

The light beams 14 emitted from the light source 22 are irradiated in a segment on the light modulator array 402, through the optical fibers 24 arranged linearly and parallel to the light modulator array 402, and the lenses 400 and 401. The light beams, which are modulated by the light modulator array 402 for each pixel in accordance with image data, are focused by the lenses 403 and 404 so as to form a segment on the surface of the photo-curable resin 12 in the direction of the Y axis. Accordingly, the segment 16B on the surface of the photo-curable resin is exposed by the linear light beams 14 at one time, and the exposed portion is cured.

When an exposure of the segment 16B at the initial positions of the exposure unit 18B has been completed, the exposure unit 18B is moved by the XY positioning mechanism 20 by one step in X direction, and another segment is exposed. Thus, due to the repetition of movement/exposure of the exposure unit 18B, a region of a predetermined area of the photo-curable resin 12 is exposed.

For example, if the spot diameter (resolution) of the light beams on the surface of the photo-curable resin 12 is 50 μm, when the exposure unit 18B having the light modulator array 402 comprising 1000 pixels is used, the segment 16B whose length is 50 mm can be exposed at one time. In this case, when the total exposure area of the surface of the photo-curable resin 12 is 500 mm×500 mm, the entire resin surface can be exposed without deteriorating the resolution by exposing the resin surface while moving the position of the exposure unit 18B.

As described above, in the optical modeling device according to the present embodiment, since the exposure unit 18B has the light modulator array 402 comprising the GLV elements, a segment having a predetermined length can be exposed at one time thus malting high speed modeling possible. Further, since the exposure unit 18B can be moved by the XY positioning mechanism 20, and the entire surface of the photo-curable resin can be exposed plural times by shifting the positions of the exposure unit, by limiting a region to be exposed by one exposure unit at one time, spatial resolution can be improved, and modeling can be carried out with high accuracy.

The light source comprising a plurality of the GaN semiconductor lasers and the multiplexing optical system can output high power and can be manufactured inexpensively. Accordingly, the entire optical modeling device can be manufactured inexpensively. Specifically, the optical modeling device of the present invention is more advantageous than a conventional optical modeling device using a gas laser such as an argon laser or a solid laser in such points that the device can be manufactured inexpensively, the maintenance thereof is facilitated, and the entire device is made compact.

The light source is disposed at the exterior of the exposure unit and the exposure unit and the light source are optically coupled by using the optical fiber, whereby the unit can be made lighter, and a load applied to the XY positioning mechanism can be reduced thus enabling the exposure unit to move at high speed.

The light source can be structured by any of the light sources exemplified in the above-described (1) to (6).

In the fourth embodiment of the present invention described above, GLV(Grating Light Valve) elements are used for the light modulator array, and a fixed mirror is used for a reflective mirror for reflecting the light beam transmitted through the condensing lens toward the surface of the photo-curable resin. However, the present invention is not limited to this, and instead, as shown in FIGS. 5A and 5B, the light modulator array can use DMD elements in which the micro mirror 240 is arranged in a row or in an array of rows.

The arrangement of the light modulator array is not strictly limited to one dimensional (i.e., the number of element is one for a dimension) line, and instead, can be structured so as to have the number of one dimensional elements which is smaller than that of another dimensional elements. By structuring the light modulator array in an area state or a linear state, a region corresponding to a plurality of pixels of the photo-curable resin can be exposed at one time, leading to a high speed exposure processing. However, if the light modulator array is structured in the area state, borders between regions of the photo-curable resin form lines. On the contrary, if the light modulator array is structured in a linear state, borders between regions of the photo-curable resin to be processed at one time form dots. With reference to such borders, an alignment processing is generally needed to carry out a matching process for respective processings. As compared to a case in which borders become lines, in a case in which borders become dots, regions to which the alignment processing is applied can be reduced, whereby the exposure processing is facilitated. Therefore, by structuring the light modulator array not in an area state but in a linear state, high speed exposure processing is made possible, and the alignment processing can be facilitated.

In the fourth embodiment of the present invention, the continuously driven gallium nitride semiconductor laser is used as a light source. However, the pulse driven gallium nitride semiconductor laser can be used. If the gallium nitride semiconductor laser whose COD level is extremely high is pulse-driven, it is possible to obtain a layered modeling at higher speed and with higher accuracy. A short pulse width is acceptable, preferably, 1 psec to 100 nsec, and more preferably, 1 psec to 300 psec.

As shown in FIG. 17, in the fourth embodiment of the present invention, the fibers 24 are disposed in an array. However, the present invention is not limited to this, and instead, the fibers 24 can be arranged in a bundle to generate a laser light in an area state. In this case, preferably, the light modulator array 402 in the area state is used.

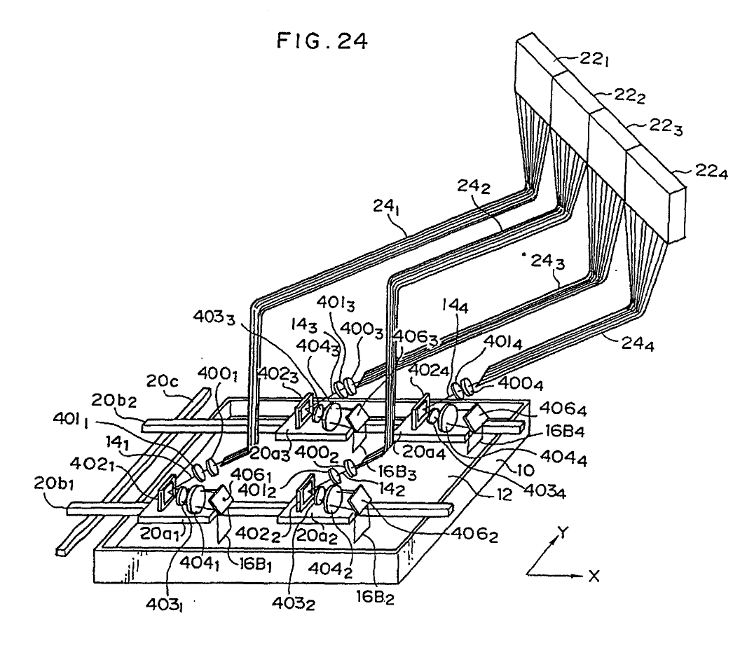

As shown in FIG. 24, the optical modeling device may comprise a plurality of exposure units and a plurality of light sources. Further, since the present embodiment is structured in the same manner as the second embodiment of the present invention except that, instead of the exposure units 18₁ to 18₄, the exposure units 18B₁ to 18B₄ are disposed and the light sources shown in FIGS. 19, 20A and 20B are used, portions identical to those in the second embodiment of the present invention are denoted by the same reference numerals, and a description thereof will be omitted. The optical modeling device comprises a plurality of the exposure units (four in the figure) each having the light modulator array, and a predetermined region of the resin surface can be exposed at one time for each exposure unit, whereby further higher speed modeling is enabled. For example, when four exposure units are used, modeling can be carried out at a speed four times faster than when only one exposure unit is used. Further, when the predetermined region of the resin surface is exposed by a plurality of the exposure units, since the region to be exposed is decentralized and cured, formation of distortion due to a localized hardening and/or contraction of the region to be exposed can be prevented. Besides, even when one part of the whole exposure units is out of order, optical modeling can be continued by another exposure unit, whereby usage stability of the device can be improved.

Fifth Embodiment

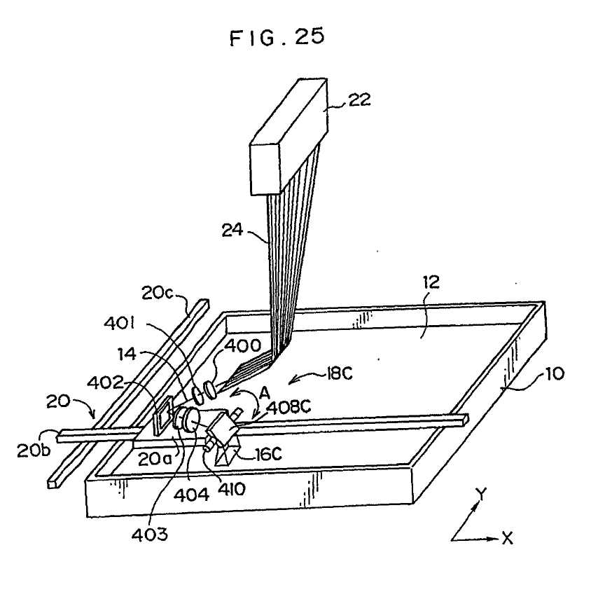

As shown in FIG. 25, since an optical modeling device according to a fifth embodiment of the present invention is structured in the same manner as in the fourth embodiment of the present invention except that, instead of the exposure unit 18B, an exposure unit 18C in which a predetermined length of a segment is exposed at one time, and scanned by the movable mirror in a direction orthogonal to the segment (in X direction in the figure), and a predetermined region 16C including a plurality of pixels on the resin surface of the photo-curable resin is exposed by the light beam 14 is used, portions identical to those in the fourth embodiment of the present invention are denoted by the same reference numerals, and a description thereof will be omitted.

As shown in FIG. 25, the exposure unit 18C comprises: the lenses 400 and 401 for irradiating the light beams 14 in a segment which is transmitted through the optical fibers 24 arranged in an array from the light source 22 of about 500W; the light modulator array 402 for modulating the light beams transmitted from the lenses 400 and 401 for each pixel in accordance with image data; the condensing lenses 403 and 404 for condensing the light beam transmitted from the light modulator array 402; and a movable reflective mirror 408C, disposed so as to be able to rotate in the direction of arrow A, for reflecting the light beam transmitted through the condensing lenses 403 and 404 towards the surface of the photo-curable resin 12. Moreover, a rotation axis mounted to the movable reflective mirror 408C is rotatably supported by a bearing (not shown).

Description of an operation of the optical modeling device described above will be given hereinafter. In the same manner as the fourth embodiment of the present invention, when the exposure within a predetermined length of a segment has been completed by the exposure unit 18C at the first position of the exposure unit 18C, the movable reflective mirror 408C of the exposure unit 18C is rotated by one step in X direction, and another segment is then exposed. Thus, due to the repetition of rotation and movement of the mirror in the X direction, a predetermined area 16C of the photo-curable resin 12 is exposed.

Upon the completion of the exposure within the predetermined area 16C at the first position of the exposure unit 18C, the exposure unit 18C is moved in X and Y directions, and a second position of the exposure unit 18C in the X and Y directions is determined, and in the same manner as described above, the predetermined area 16C corresponding to the second position is exposed. In this way, due to the repetition of movement and the exposure of the exposure unit 18C, the entire surface of the photo-curable resin 12 can be exposed.

As described above, in the optical modeling device according to the present embodiment, since the exposure unit has the light modulator array comprising GLV elements, a predetermined length of a segment can be exposed at one time. Further, since a predetermined length of the segment is exposed, and also scanned in the direction orthogonal to the segment by using the movable reflective mirror, a higher speed modeling is enabled by the device of the present embodiment when compared to the fourth embodiment of the present invention. Moreover, since the exposure unit can be moved by the XY positioning mechanism, and the entire resin surface can be exposed a plurality of times while the exposure unit is shifted, by limiting a region to be exposed by one exposure unit at one time, spatial resolution of the region can be improved thus making modeling with high accuracy possible.

The light source comprising a plurality of the GaN semiconductor lasers and the multiplexing optical system can output high power and can be manufactured inexpensively. Accordingly, the entire optical modeling device can be manufactured inexpensively. Specifically, the optical modeling device of the present invention is more advantageous than a conventional optical modeling device using a gas laser such as an argon laser or a solid laser in such points that the device can be manufactured inexpensively, the maintenance thereof is facilitated, and the entire device is made compact.

The light source is disposed at the exterior of the exposure unit and the exposure unit and the light source are optically coupled by using the optical fiber, whereby the unit can be made lighter, and a load applied to the XY positioning mechanism can be reduced thus enabling the exposure unit to move at high speed.

The light source can be structured by any of the light sources exemplified in the above-described (1) to (6).

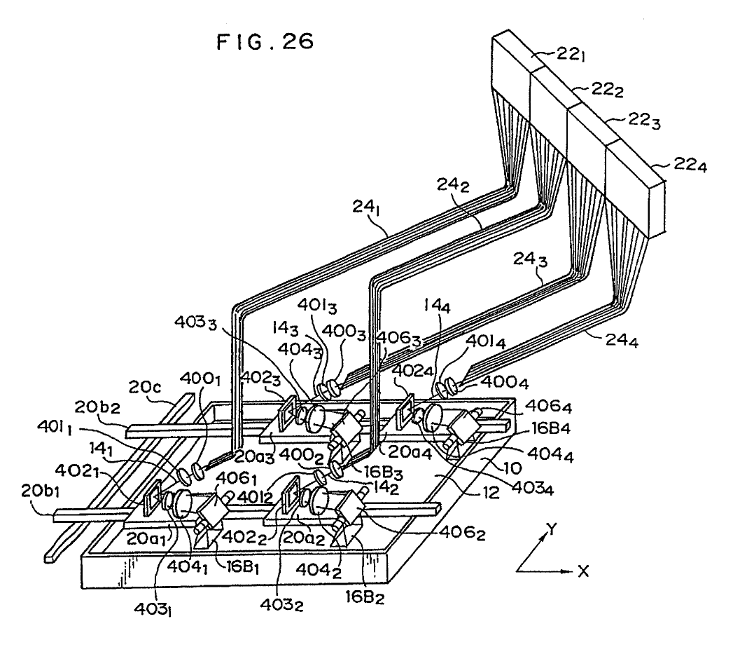

As shown in FIG. 26, the optical modeling device may comprise a plurality of exposure units and a plurality of light sources. Further, since the device of the present embodiment is structured in the same manner as in the second embodiment of the present invention except that the exposure units 18C₁ to 18C₄ are disposed instead of the exposure units 18₁ to 18₄, portions identical to those in the second embodiment of the present invention are denoted by the same reference numerals, and a description thereof will be omitted. The optical modeling device comprises a plurality of the exposure units (four in this figure) each having the light modulator array, and a predetermined region of the resin surface can be exposed at one time per each exposure unit, whereby further higher modeling is enabled. For example, when four exposure units are used, modeling can be carried out at a speed four times faster than when one single exposure unit is used. Further, since multiple exposure units are used to expose a predetermined region of the resin surface, the region to be exposed of the resin surface is decentralized and cured, formation of distortion due to a localized curing and/or contraction of the region to be exposed can be inhibited. Besides, even when one part of the whole exposure units is out of order, optical modeling can be continued by using another exposure unit, whereby usage stability of the device can be improved.

In the first, second, fourth, and fifth embodiments of the present invention, description of examples in which the exposure unit(s) is moved in X and Y directions by the XY positioning mechanism has been given. However, a container accommodating therein a photo-curable resin can be moved relative to the exposure unit.

In the first to fifth embodiments of the present invention, a spot diameter of a light beam and an amount in which light is outputted from the exposure unit can suitably be changed. Namely, modeling with high accuracy is enabled by the exposure in a small outputted light amount, while high speed modeling is enabled by the exposure in a large outputted light amount.

In the above-described fourth and fifth embodiments of the present invention, descriptions of examples in which light beams are modulated by using the light modulator array in which a reflective grating type GLV (Grating Light Valve) element i.e., an MEMS (Micro Electro Mechanical Systems) type spatial light modulator (SLM; Spatial Light Modulator) is arranged in an array. The light beams can be modulated by another modulating portion. Further, the term “MEMS” is a general term for a micro-size sensor which is manufactured by using a micro-machining technology on the basis of an IC manufacturing process, actuators, and a fine system in which control circuits are integrated. The MEMS type spatial light modulator stands for a spatial light modulator to be driven by electrical mechanical operations using static electricity.

A laser beam having a laser light source which is continuously driven and which outputs a small amount of light can be modulated by a spatial light modulator such as an optical element (PLZT element) or a liquid crystal light shutter (FLC) for modulating transmitting light due to electric optical effects, other than the MEMS type spatial light modulators. Further, a laser beam having a laser source which is pulse-driven and outputs a large amount of light can be modulated by a spatial light modulator such as another MEMS type spatial light modulator such as a digital micro mirror device (DMD), a full-reflective type spatial light modulator, or a coherent spatial light modulator.

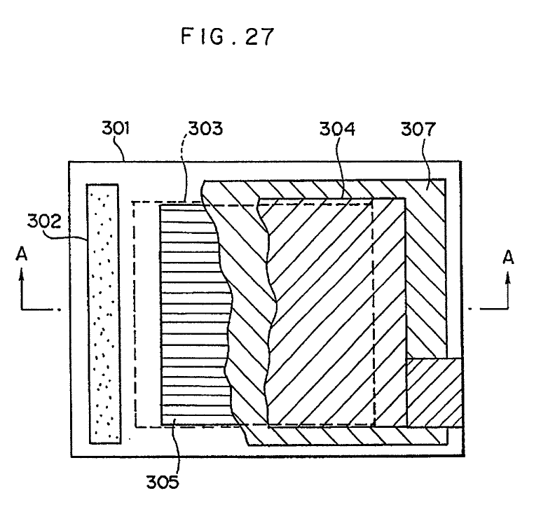

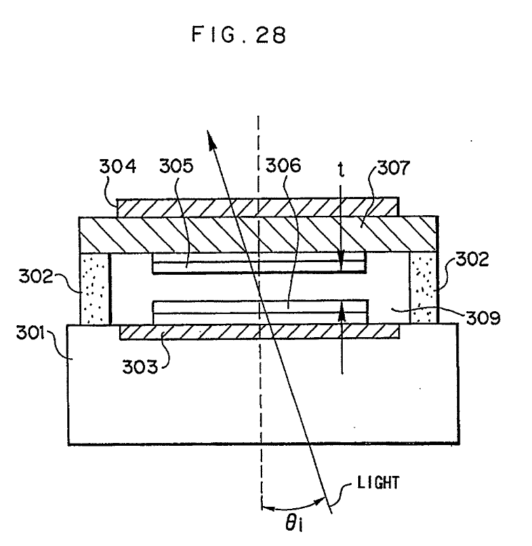

An example of the coherent spatial light modulator includes a light modulator (a coherent optical shutter) using a Fabry-Perot coherence. As shown in FIGS. 27 and 28, the coherent optical shutter comprises one electrode 303 which is disposed at a predetermined angle with respect to incident light, another electrode 304 which is disposed so as to face the one electrode 303 and separated therefrom at a gap; and a transparent flexible thin film 307 which is interposed between the one electrode 303 and the another electrode 304. On receiving Coulomb force that is generated by applying a voltage between the one electrode 303 and the another electrode 304, the coherent optical shutter flexes the flexible thin film 307, modulates the light transmitted through the flexible thin film 307, and emits the light.

The one electrode 303 is structured by being incorporated in a transparent substrate 301, and a dielectric multilayer mirror 305 is disposed above the one electrode 303. The transparent substrate 301 has supports 302 disposed at both sides thereon. The flexible thin film 307 is provided at the upper ends of the supports 302. Another dielectric multilayer mirror 306 is provided at the bottom surface of the flexible thin film 307 so as to face the dielectric multilayer mirror 305. Accordingly, the gap 309 is formed between the upper dielectric multilayer mirror 305 and the lower dielectric multiplayer mirror 306. Further, the another electrode 304 is disposed on top of the flexible thin film 307 so as to face the one electrode 303.

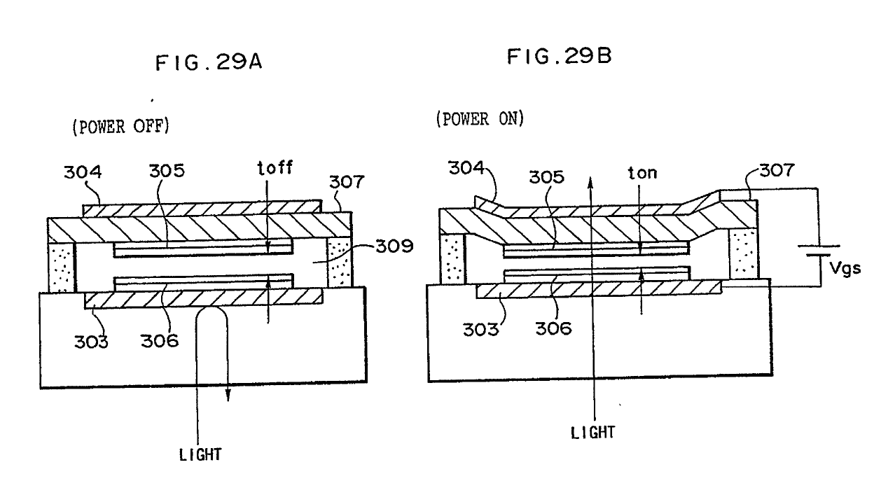

In the coherent optical shutter which is structured like this, as shown in FIG. 29A, when power supply of a power voltage V_{gs}, into the electrode 303 and the electrode 304 is switched off, the gap 309 between the dielectric multilayer mirrors 305 and 306 becomes t-off. As shown in FIG. 29B, when power supply of the power voltage V_{gs} into the first electrode 303 and the second electrode 304 is on, the gap 309 between the dielectric multilayer mirrors 305 and 306 becomes t-on. Namely, when the voltage V_{gs} is applied between the electrodes 303 and 304, Coulomb force is generated to deform the flexible thin film 307, whereby the gap 309 becomes tight.

Here, t-off can be controlled during the formation of the flexible thin film 307. Further, t-on can be controlled by balancing the voltage V_{gs} and a restoring force generated when the flexible thin film 307 deformed. In order to provide more constant control, a spacer can be formed between the electrode 303 and the flexible thin film 307 so as to keep the deformation constant. When the spacer is dielectric, it can provide an effect of reducing the applied voltage by its dielectric constant (1 or more). When the spacer is electrically conductive, the better effect can be provided. Further, the electrodes 303 and 304 can be formed by the same material.

As shown in FIG. 28, when an angle between a normal of the surface of the shutter and incident light is θi, light intensity transmittance It of the coherent optical shutter is represented by the following equation. In this equation, R represents a light intensity reflectance of each of the multilayer mirrors 305 and 306, n represents a refractive index of the gap 309 (1 in the case of air), t represents a length of the gap 309 between the dielectric multilayer mirrors 305 and 306, and λ represents an optical wavelength.

$$I t = \frac{1}{1 + 4 R {sin}^{2} [ \frac{2 π n t cos {θ}_{i}}{λ} ] \frac{1}{{( 1 - R )}^{2}}}$$

wherein t-on and t-off are determined as below (m=1): t-on=½×λ [nm], t-off=¾×λ [nm], and λ=405 nm. Further, the light intensity reflectance of each of the dielectric multilayer mirrors 305 and 306 is represented by R=0.9, incident angle is represented by θi=0[deg], and the reflective index of the gap 309 is represented by n=1 (when the gap 309 is air or noble gas). Characteristics of the coherent optical shutter with respect to a wavelength of the light intensity transmittance are such that the shutter does not transmit light when the voltage V_{gs} is not applied (in the case of t-off), and transmits light which is mainly emitted from the semiconductor laser light whose wavelength is 405 [nm] when the voltage V_{gs} is applied (in the case of t-on) the shutter.

The coherent optical shutter receives the Coulomb force generated by the application of the voltage V_{gs} between the electrodes 303 and 304, flexes the flexible thin film 307, generates multilayer coherent effect, and is able to optically modulate the transmitted light through the flexible thin film 307. Further, arbitrary combination of a distance t of the gap 309, a reflex index n, light intensity reflectance R of each of the dielectric multiplayer mirrors 305 and 306, and the like can be used provided that coherence conditions are satisfied. Moreover, when the distance t is sequentially changed on the basis of the value of the voltage V_{gs}, the central wavelength of a transmitting spectrum can arbitrarily be changed, whereby an amount of the transmitted light can be controlled continuously. Namely, gradation control due to the applied voltage is enabled.

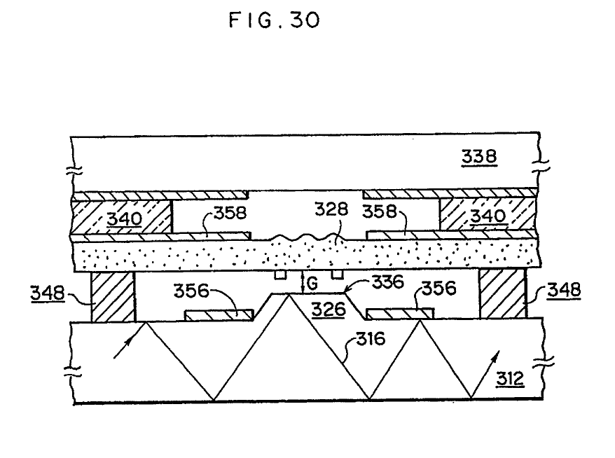

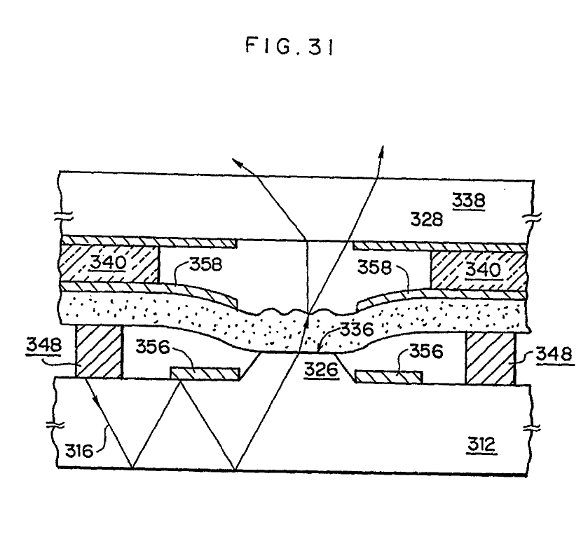

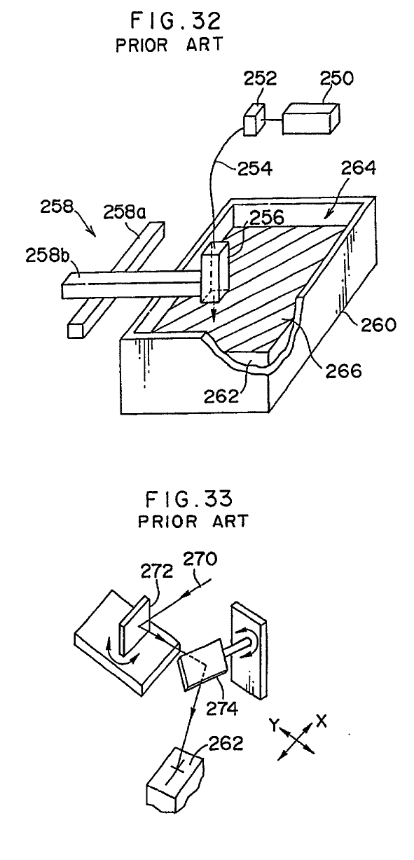

As shown in FIG. 30 and FIG. 31, in an example of a mechanical optical tap driving structure, the full-reflective light modulator has a normally-on optical tap structure. Here, an optical inducing plate mesa 326 is disposed at a lower position than spacers 348 on the optical introducing plate mesa 326. Line electrodes 356 are disposed in the vicinities of the spacers 348. Column electrodes 358 corresponding to the line electrodes 356 are disposed on top of a mechanical tap film 328. Due to a tensile nature of the mechanical tap film 328 which is normally-on structured, the level of the spacers 348 above the mesa become higher. Accordingly, the mechanical tap film 328 is held in a state of being separated from the upper surface 336 of the optical inducing plate mesa 326. A gap G of about 0.7 μm between the tap film 328 and the top surface 336 of the mesa 326 inhibits the light emitted from the optical inducing plate 312 from transmitting through the tap film 328, and a transmitting substrate 338 disposed above the tap film 328. In this state (on-state), the light enters from the left hand side of the plate 312 and emits from the right hand side thereof in FIG. 30, whereby the light can be used for exposure. On the other hand, when an appropriate potential difference is applied between the ling electrodes 356 and the column electrodes 358, these electrodes are electrically charged (not shown). As a result, the flexible tap film 328 is attracted to the optical inducing plate mesa 326 and the line electrodes 356. This positive attraction allows the tap film 328 to flex downwards, whereby the tap film 328 is moved to be kept in contact with the top surface 336 of the optical inducing plate mesa 326. As shown in FIG. 25, this sets the mechanical optical tap film 328 in off-state, and the light emitted from the optical inducing plate mesa 326 is transmitted through the mechanical tap film 328 contacting therewith, and through the transmitting substrate 338, and then escapes upwardly in this figure. In this off-state, the light entered from the left-hand side of the optical inducing plate 312 does not emit from the right-hand side thereof, and the light cannot be used for exposure. By removing electrode potentials which are attractive to each other, the tensional mechanical tap film 328 is snapped back upwardly to an ordinary rest position. The tap film 328 is separated from the top surface 336 of the optical inducing plate mesa 326, and the mechanical tap film 328 returns to on-state.

What is claimed is:

1. An optical modeling device in which a light beam is exposed onto a photo-curable resin to form a three-dimensional model, the device comprising:
an exposure portion for exposing a plurality of pixels within a predetermined region of a surface of the photo-curable resin by using the light beam emitted from a light source and modulated for each pixel in accordance with image data; and
a moving portion connected to the exposure portion for moving the exposure portion relative to the surface of the photo-curable resin.

2. An optical modeling device in which a light beam is exposed onto a photo-curable resin to form a three-dimensional model, the device comprising:
an exposure portion for exposing a plurality of pixels within a predetermined region of a surface of the photo-curable resin by using the light beam emitted from a light source, modulated for each pixel in accordance with image data, and pulse-driven in picosecond pulses; and
a moving portion connected to the exposure portion for moving the exposure portion relative to the surface of the photo-curable resin.

3. The device of claim 1, wherein the exposure portion comprises the light source, and a spatial light modulator for modulating the light beam emitted from the light source for each pixel in accordance with the image data.

4. The device of claim 3, wherein the spatial light modulator comprises a digital micromirror device.

5. An optical modeling device in which a light beam is exposed onto a photo-curable resin to form a three-dimensional model, the device comprising:
an exposure portion, which is capable of scanning, for exposing a plurality of pixels within a predetermined region of a surface of the photo-curable resin by using the light beam emitted from a light source and modulated for each pixel in accordance with image data; and
a moving portion connected to the exposure portion for moving the exposure portion relative to the surface of the photo-curable resin.

6. The device of claim 5, wherein the exposure portion comprises the light source, and a spatial light modulator array in which spatial light modulators, for modulating the light beam emitted from the light source for each pixel in accordance with image data, are arranged in a first scanning direction.

7. The device of claim 6, wherein the spatial light modulator comprises a grating light valve or a digital micromirror device.

8. The device of claim 5, wherein the exposure portion comprises: the light source; a spatial light modulator array in which spatial light modulators for modulating the light beam emitted from the light source for each pixel in accordance with the image data are arranged in a first scanning direction; and a scanning mirror for scanning in a second scanning direction intersecting the first scanning direction.

9. The device of claim 8, wherein the moving portion moves the exposure portion in the first scanning direction and the second scanning direction intersecting the first scanning direction.

10. The device of claim 1, further comprising at least one other exposure portion so that there is a plurality of the exposure portions, and the exposure portions are each independently movable relative to the surface of the photo-curable resin.

11. The device of claim 5, further comprising at least one other exposure portion so that there is a plurality of the exposure portions, and the exposure portions are each independently movable relative to the surface of the photo-curable resin.

12. An optical mode ling device in which a light beam is exposed onto a photo-curable resin to form a three-dimensional model, the device comprising an exposure portion which includes a plurality of exposure units arranged in an array, each exposure unit scanning and exposing a plurality of pixels within a predetermined region of a surface of the photo-curable resin by using a light beam emitted from a light source and modulated for each pixel in accordance with image data.

13. The device of claim 12, wherein each of the exposure units comprises the light source, a condensing optical system for condensing the light beam emitted from the light source, and a deflecting element for modulating the light beam condensed by the condensing optical system for each pixel in accordance with image data.

14. The device of claim 13, wherein the light source, the condensing optical system, and the deflecting element are enclosed in a package.

15. The device of claim 13, wherein the deflecting element comprises a two-dimensional microscanner.

16. The device of claim 1, wherein the light source comprises one of:
a gallium nitride semiconductor laser;
a semiconductor laser excitation solid laser in which a laser beam caused by excitation of a solid laser crystal by a gallium nitride semiconductor laser is wavelength-converted by an optical wavelength- converting element, and emitted;
a fiber laser or fiber amplifier in which a laser beam caused by excitation of a fiber by an infrared light-emitting semiconductor laser is wavelength-converted by an optical wavelength-converting element, and emitted; and
a fiber laser in which a laser beam caused by excitation of a fiber by a gallium nitride semiconductor laser is wavelength-converted by an optical wavelength-converting element, and emitted.

17. The device of claim 5, wherein the light source comprises one of:
a gallium nitride semiconductor laser;
a semiconductor laser excitation solid laser in which a laser beam caused by excitation of a solid laser crystal by a gallium nitride semiconductor laser is wavelength-converted by an optical wavelength- converting element, and emitted;
a fiber laser or fiber amplifier in which a laser beam caused by excitation of a fiber by an infrared light-emitting semiconductor laser is wavelength-converted by an optical wavelength-converting element, and emitted; and
a fiber laser in which a laser beam caused by excitation of a fiber by a gallium nitride semiconductor laser is wavelength-converted by an optical wavelength-converting element, and emitted.

18. The device of claim 11, wherein the light source comprises one of:
a gallium nitride semiconductor laser;
a semiconductor laser excitation solid laser in which a laser beam caused by excitation of a solid laser crystal by a gallium nitride semiconductor laser is wavelength-converted by an optical wavelength- converting element, and emitted;
a fiber laser or fiber amplifier in which a laser beam caused by excitation of a fiber by an infrared light-emitting semiconductor laser is wavelength-converted by an optical wavelength-converting element, and emitted; and
a fiber laser in which a laser beam caused by excitation of a fiber by a gallium nitride semiconductor laser is wavelength-converted by an optical wavelength-converting element, and emitted.

19. The device of claim 1, wherein the light source comprises one of:
a first laser light source in which a gallium nitride semiconductor laser is coupled to a fiber;
a second laser light source in which a plurality of gallium nitride semiconductor lasers is coupled to a fiber through a multiplexing optical system;
a linear laser light source in which a plurality of fibers of at least one of the first laser light source and the second laser light source is arranged in an array so as to emit a linear laser luminous flux; and
an area laser light source in which a plurality of fibers of at least one of the first laser light source and the second laser light source is arranged in a bundle so as to emit a spot laser luminous flux.

20. The device of claim 5, wherein the light source comprises one of:
a first laser light source in which a gallium nitride semiconductor laser is coupled to a fiber;
a second laser light source in which a plurality of gallium nitride semiconductor lasers is coupled to a fiber through a multiplexing optical system;
a linear laser light source in which a plurality of fibers of at least one of the first laser light source and the second laser light source is arranged in an array so as to emit a linear laser luminous flux; and
an area laser light source in which a plurality of fibers of at least one of the first laser light source and the second laser light source is arranged in a bundle so as to emit a spot laser luminous flux.

21. The device of claim 11, wherein the light source comprises one of:
a first laser light source in which a gallium nitride semiconductor laser is coupled to a fiber;
a second laser light source in which a plurality of gallium nitride semiconductor lasers is coupled to a fiber through a multiplexing optical system;
a linear laser light source in which a plurality of fibers of at least one of the first laser light source and the second laser light source is arranged in an array so as to emit a linear laser luminous flux; and
an area laser light source in which a plurality of fibers of at least one of the first laser light source and the second laser light source is arranged in a bundle so as to emit a spot laser luminous flux.

22. The device of claim 1, wherein the light source comprises a plurality of laser light sources, and a multiplexing optical system for multiplexing the laser beams emitted from the plurality of laser light sources.

23. The device of claim 5, wherein the light source comprises a plurality of laser light sources, and a multiplexing optical system for multiplexing the laser beams emitted from the plurality of laser light sources.

24. The device of claim 11, wherein the light source comprises a plurality of laser light sources, and a multiplexing optical system for multiplexing the laser beams emitted from the plurality of laser light sources.

25. An exposure unit for exposing a plurality of pixels, the unit comprising a light source, a condensing optical system for condensing a light beam emitted from the light source, and a deflecting element for modulating the light beam condensed by the condensing optical system for each pixel in accordance with image data.

26. An exposure unit for exposing a plurality of pixels, the unit comprising a light source, a condensing optical system for condensing a light beam which is emitted from the light source and is pulse-driven in picosecond pulses, and a deflecting element for modulating the light beam condensed by the condensing optical system for each pixel in accordance with image data.

27. The exposure unit of claim 25, wherein the light source, the condensing optical system, and the deflecting element are enclosed in a package.

28. The exposure unit of claims 25, wherein the deflecting element comprises a two-dimensional microscanner.

29. The exposure unit of claim 25, wherein the light source comprises one of:
a gallium nitride semiconductor laser;
a semiconductor laser excitation solid laser in which a laser beam caused by excitation of a solid laser crystal by a gallium nitride semiconductor laser is wavelength-converted by an optical wavelength- converting element, and emitted;
a fiber laser or fiber amplifier in which a laser beam caused by excitation of a fiber by an infrared light-emitting semiconductor laser is wavelength-converted by an optical wavelength-converting element, and emitted; and
a fiber laser in which a laser beam caused by excitation of a fiber by a gallium nitride semiconductor laser is wavelength-converted by an optical wavelength-converting element, and emitted.

30. The exposure unit of claim 25, wherein the light source comprises one of:
a first laser light source in which a gallium nitride semiconductor laser is coupled to a fiber;
a second laser light source in which a plurality of gallium nitride semiconductor lasers is coupled to a fiber through a multiplexing optical system;
a linear laser light source in which a plurality of fibers of at least one of the first laser light source and the second laser light source is arranged in an array so as to emit a linear laser luminous flux; and
an area laser light source in which a plurality of fibers of at least one of the first laser light source and the second laser light source is arranged in a bundle so as to emit a spot laser luminous flux.

31. The exposure unit of claim 25, wherein the light source comprises a plurality of laser light sources, and a multiplexing optical system for multiplexing the light beams emitted from the plurality of the laser light sources.
